(19) United States
(12) Patent Application Publication
(10) Pub. No.: US 2024/0047805 A1
(43) Pub. Date: Feb. 8, 2024

(54) BATTERY PACK AND VEHICLE

(71) Applicant: HONDA MOTOR CO., LTD., Tokyo (JP)

(72) Inventors: Chuyun Guo, Guangzhou (CN); Yaozhong Huo, Guangzhou (CN)

(21) Appl. No.: 18/227,340

(22) Filed: Jul. 28, 2023

(30) Foreign Application Priority Data
Aug. 4, 2022 (CN) 202210932022.6

(51) Int. Cl. H01M 50/242; H01M 50/258; H01M 50/204; H01M 50/298; H01M 50/262; H01M 10/613; H01M 10/625; H01M 10/6554; H01M 10/6556; H01M 10/6568; H01M 50/249

(52) U.S. Cl. CPC H01M 50/242; H01M 50/258; H01M 50/204; H01M 50/298; H01M 50/262; H01M 10/613; H01M 10/625; H01M 10/6554; H01M 10/6556; H01M 10/6568; H01M 50/249; H01M 2220/20; B60L 50/64

(57) ABSTRACT

A battery pack and a vehicle having the battery pack are capable of suppressing a reduction in the strength of the battery pack. The battery pack comprises: a housing, the housing comprising a base plate; a battery module configured on the base plate and comprising a first battery module and a second battery module, a gap provided between the first battery module and the second battery module; a low-voltage connection assembly provided in the gap and electrically connected to the battery module; a reinforcement member provided on the base plate and comprising an arch-shaped part configured in the gap and arched upward, the low-voltage connection assembly passing through the inner side of the arch-shaped part.

### CROSS-REFERENCE TO RELATED APPLICATION

Priority is claimed on Chinese Patent Application No. 202210932022.6, filed on Aug. 4, 2022, the contents of which are incorporated herein by reference.

### BACKGROUND OF THE INVENTION

### Field of the Invention

The present invention relates to a battery pack and a vehicle.

### Description of Related Art

In electric vehicles equipped with battery packs, the safety of the battery pack is very important. In order to prevent the battery pack from catching fire or failing in case of impact, etc., the battery pack is usually equipped with a reinforcement member inside the housing. In addition, there is a cable bundle inside the housing. Regarding to the configuration of the cable bundle and the reinforcement member, in a currently existing example of such a structure, for example, in order to reduce the space occupation, the cable bundle is placed in the gap between multiple battery modules, while in order not to interfere with the cable bundle, the reinforcement member is provided with a breach for the cable bundle to pass through or the reinforcement member is disconnected.

However, providing a breach in the reinforcement member or disconnecting the reinforcement member in such a way that the strength of the reinforcement member is degraded in turn causes the strength of the battery pack to be degraded.

### SUMMARY OF THE INVENTION

The present invention provides a battery pack and a vehicle that can enhance the strength of the battery pack.

According to the first aspect of the invention, provided is a battery pack comprising: a housing comprising a base plate; a battery module configured on the base plate and comprising a first battery module and a second battery module, a gap provided between the first battery module and the second battery module; a low-voltage connection assembly provided in the gap and electrically connected to the battery module; a reinforcement member provided on the base plate and comprising an arch-shaped part provided in the gap and arched upward, the low-voltage connection assembly passing through the inner side of the arch-shaped part.

With the above structure, due to the arch-shaped part, the low-voltage connection assembly passes through the inner side of the arch-shaped part, so that it is possible to suppress interference between the reinforcement assembly and the low-voltage connection assembly, and thus the low-voltage connection assembly can be easily disposed in the gap between the first battery module and the second battery module, making the structure compact. In addition, the arch-shaped part can effectively disperse the force, for example, by suppressing the degradation of the strength of the reinforcement member compared with the arrangement of breach and the like, therefore the strength of the battery pack can be enhanced to be able to better cope with collisions.

As a possible implementation of the first aspect, the battery pack further comprises a first connection member and a second connection member provided on the base plate, the first connection member and the second connection member extending in the extension direction of the base plate, the two ends of the reinforcement member secured on each of the first connection member and the second connection member.

With the above structure, the reinforcement member, the first connection member and the second connection member constitute the reinforcement assembly, and the reinforcement member, the first connection member and the second connection member can be molded separately, thereby enabling easy fabrication of a reinforcement assembly that is generally longer overall. In addition, it is also possible to easily assemble or disassemble the reinforcement assembly.

As a possible implementation of the first aspect, the battery pack further comprises a control means provided in the gap and electrically connected to the battery module via the low-voltage connection assembly.

With the above structure, the reinforcement member with the arch-shaped part is provided independently of the first and second connection members, making it possible to easily form the reinforcement member with a more complex shape.

As a possible implementation of the first aspect, the reinforcement member comprises the arch-shaped part and an upright part, the upright part extending downwards from the two ends of the arch-shaped part, and the upright part overlapping with the first connection member and/or the second connection member when viewed from the extension direction of the first connection member and the second connection member.

With the above structure, the upright part is provided to overlap the first connection member or the second connection member when viewed from the extension direction of the first connection member and the second connection member (which is understood to be the extension direction of the reinforcement assembly as a whole), that is, the upright part faces the first connection member or the second connection member, so that the force applied to the first connection member or the second connection member can be easily transferred to the arch-shaped part by the upright part, and the ability of the reinforcement member to resist impact can be improved and the strength of the battery pack can be enhanced.

As a possible implementation of the first aspect, the arch-shaped part is provided with a plurality of recesses.

With the above structure, it is possible to reduce the weight of the arch-shaped part while maintaining the strength of the arch-shaped part, thus reducing the weight of the battery pack.

As a possible implementation of the first aspect, the reinforcement member comprises a secure part, a bolt passing through the secure part and the first connection member or the second connection member in sequence and secured on the base plate.

With the above structure, it is possible to simplify the structure and improve the installation efficiency by sharing (sharing bolts, etc.) the secure structure of the first and second connection members secured on the base plate and the secure structure of the connection members secured on the first and second connection members.

As a possible implementation of the first aspect, the battery pack further comprises a first high-voltage connection assembly, the base plate provided with a receiving section, the first high-voltage connection assembly accommodated in the receiving section.

With the above structure, the first high-voltage assembly is provided in the receiving section inside the base plate, which, on the one hand, makes the structure of the battery pack more compact and improves the utilization of space inside the battery pack; on the other hand, it is possible to suppress the deformation or breakage of the high-voltage cable bundle caused by the moving battery module impacting or squeezing the high-voltage cable bundle in the event of a lateral collision of the vehicle in the case of installation on the vehicle, which improves the safety and reliability of the battery pack.

As a possible implementation of the first aspect, the base plate is provided with a coolant channel.

With such a structure, the base plate is provided with coolant channels, and therefore the base plate needs to have a certain thickness. In the embodiment of the present invention, such a base plate is provided with the receiving section to receive the electrical connection members, which does not increase the thickness of the base plate and facilitates the miniaturization of the battery pack.

As a possible implementation of the first aspect, the reinforcement member is provided over the base plate.

With the above structure, it is possible to prevent the reinforcement member from interfering with the coolant channel.

As a possible implementation of the first aspect, the part of the coolant channel distant from the centerline of the base plate is upstream along the liquid flow and the part of the coolant channel closer to the centerline of the base plate is downstream along the liquid flow, wherein the centerline extends in the extension direction of the base plate.

With the above structure, since the part of the battery module on the outer part is more susceptible to external influence, cooling the part on the outer part first can provide good cooling to the battery module.

As a possible implementation of the first aspect, the housing is provided with a first connector and a second connector at the front and rear ends, respectively; and the battery pack further comprises a power distribution unit provided over the individual battery module and electrically connected to the battery module, electrically connected to the first connector via the first high-voltage connection assembly, as well as electrically connected to the second connector via the second high-voltage connection assembly.

With the above structure, the power distribution box is positioned above the battery module to reduce the overall space occupied by the battery pack and increase the energy density of the battery pack.

As a possible implementation of the first aspect, the first high-voltage connection assembly comprises a high-voltage cable bundle and a high-voltage cable bundle support, the high-voltage cable bundle disposed in the receiving section, the high-voltage cable bundle support covering the high-voltage cable bundle from above and forming a ceiling of the receiving section.

With the above structure, the receiving section is formed by the recess and the support to receive the high-voltage cable bundle, which not only makes reasonable use of the space of the housing, but also ensures the strength of the housing.

As a possible implementation of the first aspect, a cushioning member is provided between the high-voltage cable bundle support and the reinforcement member.

With the above structure, the pressure of the reinforcement member on the high-voltage cable bundle support and the noise generated by the crash against the high-voltage cable bundle support can be reduced.

As a possible implementation of the first aspect, the low-voltage connection assembly comprises a low-voltage cable bundle and a low-voltage cable bundle support, the low-voltage cable bundle secured on the high-voltage cable bundle support via the low-voltage cable bundle support.

With the above structure, the low voltage cable bundle is secured on the high-voltage cable bundle support by the low-voltage cable bundle support, thus enabling the high-voltage cable bundle and low-voltage cable bundle to be treated as a whole for easy assembly and management. In addition, it is possible to reduce space occupation and provide space utilization inside the housing.

As a possible implementation of the first aspect, the battery module comprises a first battery module and a second battery module, a gap provided between the first battery module and the second battery module, the low-voltage connection assembly provided in the gap, the battery pack further comprising a control means, the control means provided in the gap, located between the control means and the second battery module and located below the control means.

With the above structure, the control means is provided in the gap between the first battery module and the second battery module, and thus the gap between the first battery module and the second battery module is used to provide the control means, which enables a compact structure of the battery pack and facilitates miniaturization of the battery pack, thereby increasing the energy density of the battery pack, and also facilitating assembly. In addition, for example, the height position of the control means can be decreased compared to the structure in which the control means is provided above the battery module, so that the height dimension of the housing of the battery pack is smaller in the part where the control means is received, thereby facilitating the miniaturization of the battery pack.

In addition, with the above structure, the low-voltage connection assembly and the control means are arranged together in the gap between the first battery module and the second battery module, which can further enable the structure to be compact and facilitate the miniaturization of the battery pack.

Furthermore, in the gap, the low-voltage connection assembly is positioned between the control means and the second battery module, i.e., the low-voltage connection assembly and the control means are configured misaligned when viewed in the up-down direction, thus allowing the operator to easily operate both the control means and the low-voltage connection assembly, avoiding mutual interference between the operations of the two.

In addition, the low-voltage connection assembly is positioned below the control means, thus enabling stable positioning and reliable performance of the low-voltage connection assembly.

As a possible implementation of the first aspect, the control means is secured on the base plate via the control means support. The control means support comprises a main part and a base part. The main part is configured vertically with respect to the base plate, holding the control means. The base part is bent from the lower end of the main part and mounted on the base plate.

With the above structure, the control means support is formed into an L-shaped support, and the upper part of the L-shaped support occupies less space, which improves the space utilization inside the battery pack, and achieves a firm and reliable connection at the bottom.

According to a second aspect of the present invention, provided is a vehicle comprising a battery pack of any one of the structures according to the first aspect.

With the vehicle according to the second aspect, the same technical performance can be obtained as in the first aspect, which is not repeatedly described here.

### BRIEF DESCRIPTION OF THE DRAWINGS

The various features of the present invention and the relationships between the various features are further described below with reference to the accompanying drawings. The accompanying drawings are exemplary, some features are not shown to actual scale, and some of the accompanying drawings may omit features that are common in the field to which the present application pertains and are not essential to the present application, or additionally show features that are not essential to the present application, and the combination of features shown in the accompanying drawings is not intended to limit the present application. In addition, the same reference symbols of the accompanying drawings are the same throughout the specification. The specific accompanying drawings are illustrated as follows:

FIG. 1 is a schematic diagram of a vehicle related to one embodiment of the present invention;

FIG. 2 is a schematic diagram of the principle of a battery pack related to an embodiment of the present invention;

FIG. 3 is a schematic diagram of a structure of a battery pack related to an embodiment of the present invention;

FIG. 4 is a schematic diagram of the structure of a battery pack related to an embodiment of the present invention;

FIG. 5 is a schematic diagram of the three-dimensional structure of the battery pack of FIG. 4 in a state with the top cover removed;

FIG. 6 is a schematic diagram of the structure of the battery pack of FIG. 4 in a top view with the top cover removed;

FIG. 7 is a schematic diagram of a portion of the structure of the housing of the battery pack of FIG. 4;

FIG. 8 is a schematic diagram of the structure in FIG. 7 in a state with the high-voltage cable bundle removed;

FIG. 9 is a schematic diagram of the structure of the high-voltage cable bundle related to one embodiment of the present invention;

FIG. 10 is a schematic diagram of the three-dimensional structure of the reinforcement member related to an embodiment of the present invention;

FIG. 11 is a cross-sectional schematic view of the structure in FIG. 6;

FIG. 12 is a partially enlarged view of the structure in FIG. 11;

FIG. 13 is another cross-sectional schematic view of the structure in FIG. 6;

FIG. 14 is a partially enlarged view of the structure in FIG. 13;

FIG. 15a is another partially enlarged view of the structure in FIG. 13;

FIG. 15b is a partial cross-sectional schematic view of the base plate in FIG. 15a;

FIG. 16 is a schematic diagram of the assembled state of the low-voltage connection assembly and control means and its surrounding structures related to one embodiment of the present invention;

FIG. 17 is a schematic diagram of the structure in FIG. 16 in a disassembled state;

FIG. 18 is a schematic diagram of the assembled state of the low-voltage connection assembly related to an embodiment of the present invention;

FIG. 19 is a schematic diagram of the structure in FIG. 18 in a disassembled state;

FIG. 20 is a partially enlarged view of the structure in FIG. 18;

FIG. 21a is a schematic diagram of the structure of the assembled state of the high-voltage harness support and the control means support related to one embodiment of the present invention;

FIG. 21b is a partially enlarged view of the structure illustrated in FIG. 21a;

FIG. 21c is another partially enlarged view of the structure illustrated in FIG. 21a;

FIG. 21d is yet another partially enlarged view of the structure illustrated in FIG. 21a;

FIG. 22a is a schematic diagram of a three-dimensional structure of an assembled state of a battery module, a power distribution unit support and a power distribution unit related to an embodiment of the present invention;

FIG. 22b is a top schematic view of the structure in FIG. 22a;

FIG. 23 is a schematic structural view of the structure of FIG. 22a in a disassembled state;

FIG. 24 is a schematic diagram of the three-dimensional structure of a power distribution unit support related to an embodiment of the present invention;

FIG. 25 is a schematic diagram of the three-dimensional structure of a battery module related to an embodiment of the present invention;

FIG. 26 is a schematic diagram of a three-dimensional structure of the power distribution unit related to an embodiment of the present invention;

FIG. 27 is a schematic top view of a power distribution unit related to an embodiment of the present invention;

FIG. 28a is a schematic diagram of a three-dimensional structure of a control means in an embodiment of the present invention;

FIG. 28b is a schematic side view of the control means;

FIG. 28c is a schematic elevation view of the control means;

FIG. 28d is another schematic diagram of a three-dimensional structure of the control means;

FIG. 29 is a schematic diagram for illustrating the structure of the bayonet part related to an embodiment of the present invention;

FIG. 30 is a schematic diagram of the structure of a battery pack related to an embodiment of the present invention, the structure of which differs from that in the embodiment shown in FIG. 4;

FIG. 31a to FIG. 31f show some examples of a base plate and a receiving section in the base plate.

### BRIEF DESCRIPTION OF THE REFERENCE SYMBOLS

10, housing; 11, base plate; 11a, protrusion; 12, side plate; 13, top cover; 14, lugs; 15, window plate; 16d, bolt; 16e, nut; 20, battery module; 20a, main body; 20b, mounting hole; 20c, lead terminal; 20L, battery module; 20R, battery module; 21, bolt (first bolt); 22, nut; 31, power distribution unit; 31a, mounting hole; 31b, lead terminal; 31c, lead terminal; 31d, lead terminal; 32, power distribution unit support; 32a, mounting hole; 33, bolt (second bolt); 34, nut; 41, control means; 42, control means support; 42a, main part; 42b, base part; 42c, cable bundle securing part; 44, ring support 50, high-voltage connection assembly (an example of a first high-voltage connection assembly, an electrical connection assembly); 51, high-voltage cable bundle (an example of a cable bundle); 51a, conductive member; 51b, covering layer; 51c, protrusion; 52, connector; 53, connector; 55, high-voltage connection assembly (an example of a second high-voltage connection assembly); 58, terminal block; 60, low-voltage connection assembly; 61, low-voltage cable bundle (an example of a cable bundle); 62, low-voltage cable bundle support; 63, ring support; 64, ring support; 65, connector; 66, connector; 70, reinforcement assembly; 71, first connection member; 72, reinforcement member; 72a, arch-shaped part; 72b, upright part; 72c, secure part; 72d, recess; 72e, opening; 73, second connection member; 100, battery pack; 101, connection port; 102, connection port; 111, plate; 112, high-voltage harness support; 112a, main part; 112b, bulging part; 113, receiving section; 114, bayonet part; 115, coolant channel; 116, plate; 116a, opening; 118, plate; 200, vehicle; 201, wheel; 202, wheel; 203, wheel; 204, wheel; 210, motor (an example of a first motor); 220, motor (an example of a second motor); 321, top; 321a, stiffener; 322, side; 611, main cable; 612, branch cable; 621, main part; 623, cable bundle securing part.

### DETAILED DESCRIPTION OF THE INVENTION

Some embodiments of the present invention are described in detail below with reference to the accompanying drawings. In the following description, directions such as forward, backward, left, right, up and down are defined in terms of the driver in the vehicle; however, these directions are defined for ease of description and are not a limitation of the present invention. In addition, these directions are also indicated in some of the accompanying drawings.

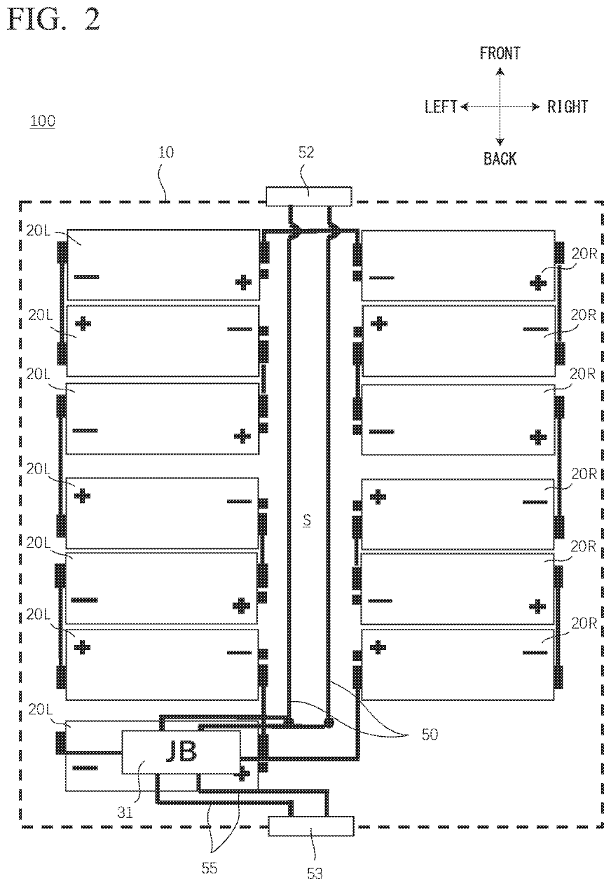

As shown in FIGS. 2 to 4, etc., in one embodiment of the present invention, provided is a battery pack 100 comprising: a housing 10 comprising a base plate 11; a battery module 20 configured on the base plate 11 and comprising a battery module 20L and a battery module 20R, a gap S provided between the battery module 20L and the battery module 20R; and a low-voltage connection assembly 60 provided in the gap S and electrically connected to the battery module 20.

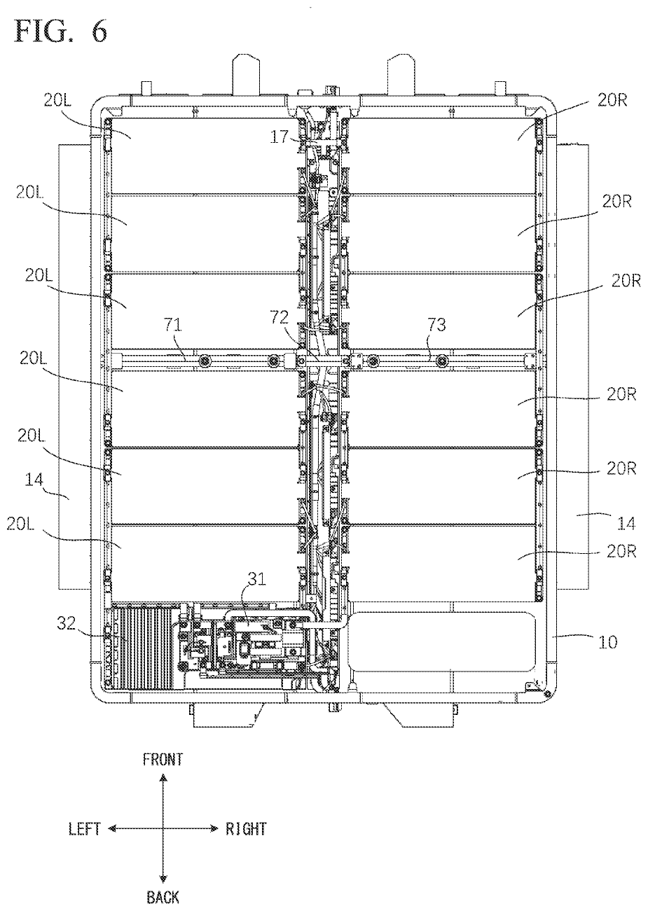

In addition, as shown in FIGS. 6 to 8 and FIGS. 10 to 12, the battery pack 100 further comprises a reinforcement member 72 provided on the base plate 11 and comprising an arch-shaped part 72a (part or all of it) provided in the gap S and arched upward, the low-voltage connection assembly 60 passing through the inner side of the arch-shaped part 72a. Optionally, in one embodiment, when the base plate 11 is provided with a horizontal beam (not shown), the reinforcement member 72 may be provided on the horizontal beam, in which case the portion of the horizontal beam opposite the gap S is provided with a recess, and the reinforcement member 72 is located over the recess.

With the above structure, as the reinforcement member 72 is provided with the arch-shaped part 72a, the low-voltage connection assembly 60 passes through the inner side of the arch-shaped part 72a, so that it is possible to suppress interference between the reinforcement assembly 70 and the low-voltage connection assembly 60, so that the low-voltage connection assembly 60 can be easily disposed in the gap S between the battery module 20L and the battery module 20R, enabling the structure to be compact. In addition, the arch-shaped part 72a can effectively disperse the force, for example, by suppressing the degradation of the strength of the reinforcement assembly 70 compared with the breach and the like, so that the strength of the battery pack 100 can be enhanced to be able to better cope with impacts.

As will be described later, the arch 72a can be formed independently of other parts such as the first connection member 71 and the second connection member 73. However, they may also be formed in integral form.

Optionally, in one embodiment, as shown in FIGS. 6 to 8 and FIGS. 10 to 12, As a possible implementation of the first aspect, the battery pack 100 further comprises a first connection member 71 and a second connection member 73. The first connection member 71 and the second connection member 73 extend in the extension direction of the base plate 11, and the ends of the reinforcement member 72 are secured on each of the first connection member 71 and the second connection member 73. The first connection member 71, the reinforcement member 72 and the second connection member 73 as a whole form the reinforcement assembly 70.

With the above structure, the first connection member 71, the reinforcement member 72 and the second connection member 73 can be formed separately, thereby enabling easy fabrication of a reinforcement assembly 70 that is generally longer overall. In addition, it is also possible to easily assemble or disassemble the reinforcement assembly 70.

With regard to the way the reinforcement member 72 is secured on the first connection member 71 and the second connection member 73, for example, a bolt may be used for securing, or riveting, welding, snap-fitting, etc. may also be used. It will be understood that the reinforcement member 72, the first connection member 71 and the second connection member 73 can also be formed as a whole to form a single reinforcement member.

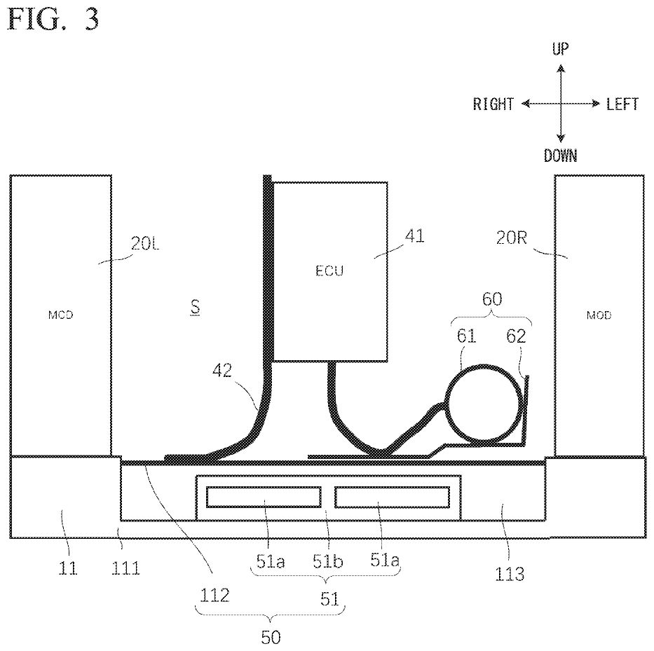

Optionally, in one embodiment, as shown in FIGS. 3, 12 and 15a, the battery pack 100 further comprises a control means 41 provided in the gap S and electrically connected to the battery module 20 via the low-voltage connection assembly 60. As shown in FIGS. 6 to 8 and 10 to 12, the reinforcement member 72 is provided with an arch-shaped part 72a, and the low-voltage connection assembly 60 is electrically connected to the battery module 20 via the inner side of the arch-shaped part 72a. The reinforcement member 72 is formed separately from the first connection member 71 and the second connection member 73.

With the above structure, the reinforcement member 72 with the arch-shaped part 72a is provided independently of the first connection member 71 and the second connection member 73, making it possible to easily form the reinforcement member 72 with a more complex shape.

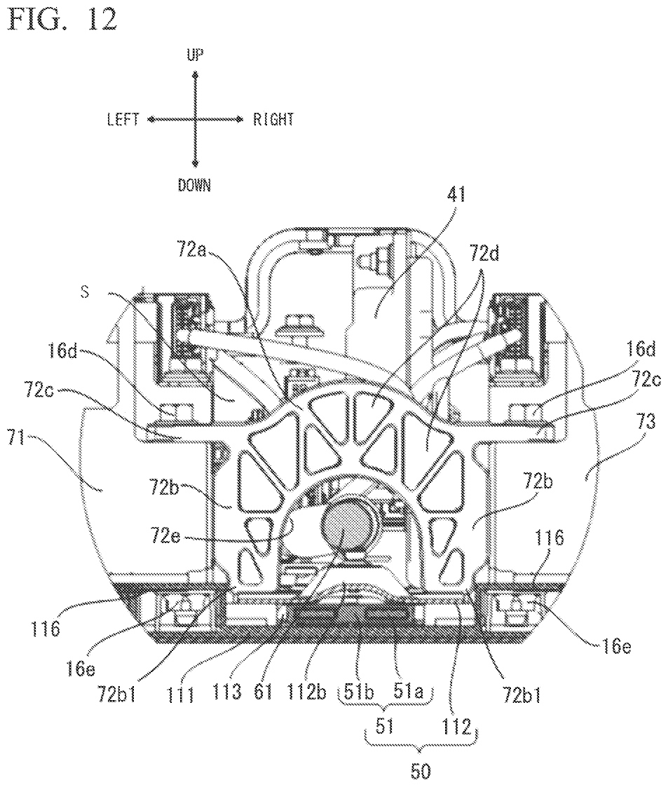

Optionally, in one embodiment, as shown in FIG. 12, etc., the reinforcement member 72 comprises the arch-shaped part 72a and an upright part 72b. The upright part 72b extends downwards from the two ends of the arch-shaped part. The upright part 72b overlaps with the first connection member 71 and/or the second connection member 73 when seen from the extension direction of the first connection member 71 and the second connection member 73.

With the above structure, the upright part 72b is provided so that the upright part 72b overlaps with the first connection member 71 and the second connection member 73 when seen from the extension direction of the first connection member 71 and the second connection member 73, that is, the upright part 72b faces the first connection member 71 and the second connection member 73, so that the force applied to the first connection member 71 or the second connection member 73 can be easily transferred to the arch-shaped part 72a by the upright part 72b, and the ability of the reinforcement assembly 70 to resist impact can be improved and the strength of the battery pack 100 can be enhanced.

The present invention is not limited to this, and the above-mentioned upright part 72b can be omitted.

Optionally, in one embodiment, as shown in FIG. 12, etc., the arch-shaped part 72a is provided with a plurality of recesses 72d.

With the above structure, it is possible to reduce the weight of the arch-shaped part 72awhile ensuring the strength of the arch-shaped part 72a, thus reducing the weight of the battery pack 100.

Optionally, in one embodiment, as shown in FIG. 12, etc., the reinforcement member 72 comprises a secure part 72c. The bolts 16d pass through the secure part 72c and the first connection member 71 or the second connection member 73 in sequence and are secured on the base plate 11.

With the above structure, it is possible to simplify the structure and improve the installation efficiency by sharing the secure structure of the first and second connection members 71 and 73 secured on the base plate 11 and the secure structure of the reinforcement member 72 secured on the first and second connection members 71 and 73.

It will be understood that the present invention is not limited to this and that instead of securing the reinforcement member 72 by means of bolts 16d, it can be secured on the first connection member 71 or the second connection member 73 using other secure structures.

Optionally, in one embodiment, as shown in FIG. 3, the battery pack 100 further comprises a high-voltage connection assembly 50, the base plate 11 provided with a receiving section, the high-voltage connection assembly 50 accommodated in the receiving section 113.

With the above structure, the high-voltage assembly 50 is provided in the receiving section 113 inside the base plate, which, on the one hand, makes the structure of the battery pack 100 more compact and improves the utilization of space inside the battery pack 100; on the other hand, it is possible to suppress the deformation or breakage of the high-voltage cable bundle caused by the moving battery module 20 impacting or squeezing the high-voltage cable bundle in the event of a lateral collision of the vehicle in the case of installation on the vehicle, which improves the safety and reliability of the battery pack 100.

Optionally, in one embodiment, the lower end 72b1 of the upright part 72b goes down into the receiving section 113 as shown in FIG. 12.

Accordingly, for example, when the vehicle is subjected to a lateral impact, the receiving section 113 is deformed by contraction in the left-right direction, and in this case, the left-right side walls of the receiving section 113 (i.e., the left-right side walls of the recess) are in contact with the lower end 72b1 of the upright part 72b, so that the external force in the left-right direction is held by the reinforcement member 72 and the strength of the base plate 11 in the left-right direction is improved.

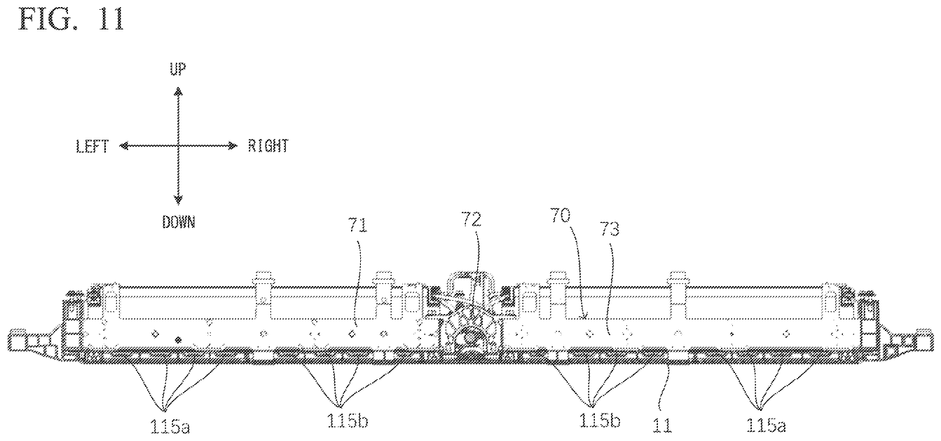

Optionally, in one embodiment, as shown in FIGS. 11, 13 and 14, the base plate 11 is provided with a coolant channel 115.

With such a structure, the base plate 11 is provided with coolant channels 115, so the base plate 11 needs to have a certain thickness to arrange the coolant channels 115. In the embodiment of the present invention, such a base plate 11 is provided with the receiving section 113 to receive the electrical connection components, which does not increase the thickness of the base plate 11 and facilitates the miniaturization of the battery pack 100.

Optionally, in one embodiment, as shown in FIG. 12, the reinforcement member 72 is provided over the base plate 11.

With the above structure, the reinforcement member 72 can be prevented from interfering with the coolant channels 115.

Optionally, in one embodiment, as shown in FIG. 11, in the coolant channels 115, the part distant from the centerline X (FIG. 8) of the base plate 11 is upstream along the liquid flow and the part closer to the centerline X of the base plate 11 is downstream along the liquid flow, wherein the centerline X extends in the extension direction of the base plate.

With the above structure, since the part of the battery module 20 on the outer part is more susceptible to external influence, cooling the part on the outer part first can provide good cooling to the battery module 20 in this embodiment.

Optionally, in one embodiment, as shown in FIG. 2, as a possible implementation of the first aspect, the housing 10 is provided with a connector 52 and a connector 53 at the front and rear ends, respectively; the battery pack 100 further comprises a power distribution unit 31 provided over the individual battery module 20 and electrically connected to the battery module 20, electrically connected to the connector 52 via the high-voltage connection assembly 50, as well as electrically connected to the connector 53 via the high-voltage connection assembly 55.

With the above structure, the power distribution unit 31 is positioned over the battery module 20 to reduce the overall space occupied by the battery pack 100 and increase the energy density of the battery pack 100.

Optionally, in one embodiment, as shown in FIGS. 3, 12, 15a, 16 and 17, the high-voltage connection assembly 50 comprises a high-voltage cable bundle 51 and a high-voltage cable bundle support 112. The high-voltage cable bundle 51 is disposed in the receiving section 113. The high-voltage cable bundle support 112 covers the high-voltage cable bundle from above and forms a ceiling of the receiving section 113.

With the above structure, the receiving section 113 is formed by the recess and support to receive the high-voltage cable bundle, which not only makes reasonable use of the space of the housing 10, but also ensures the strength of the housing 10.

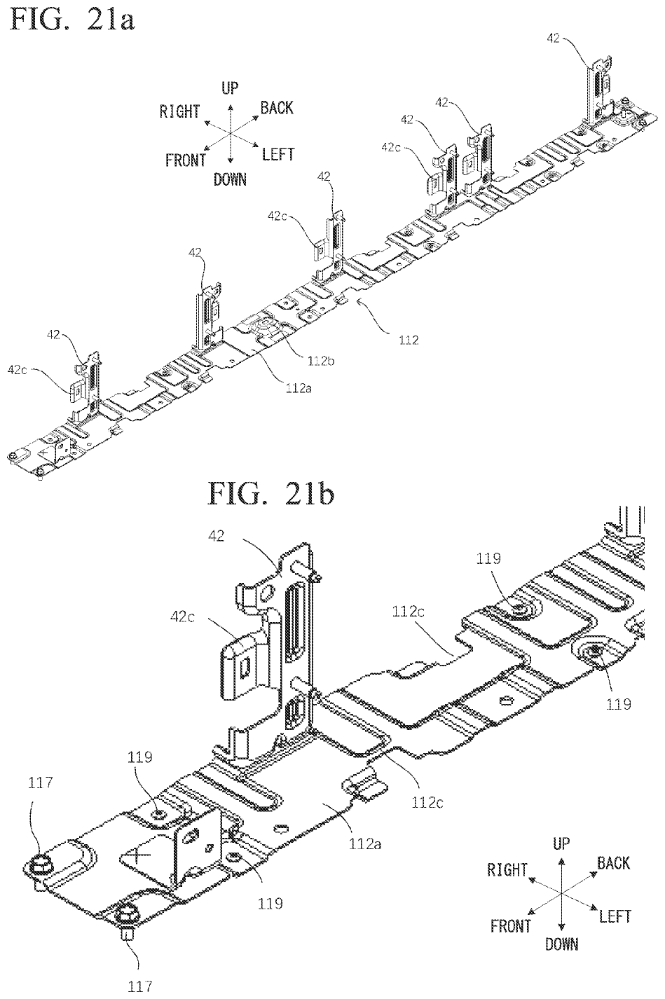

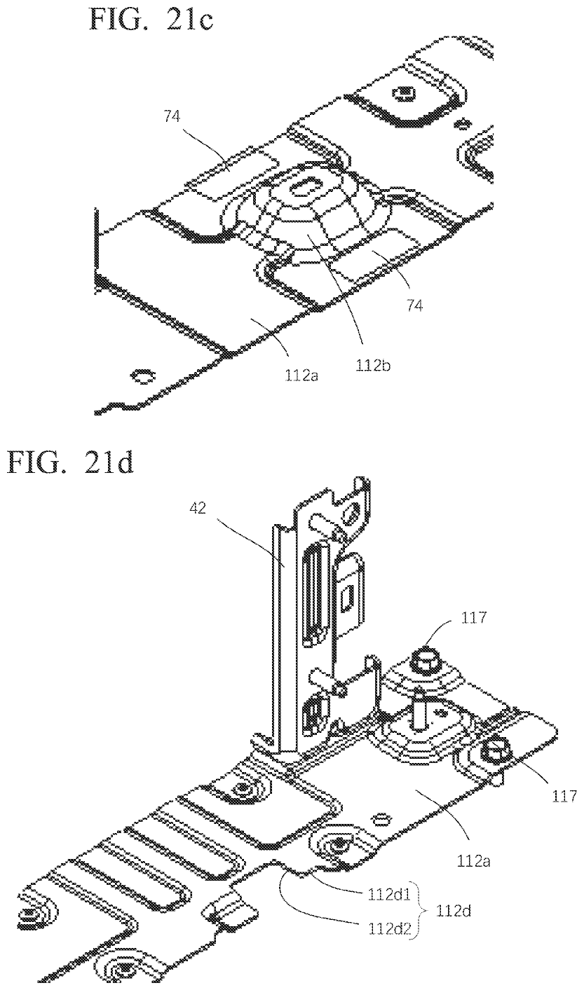

Optionally, in one embodiment, as shown in FIG. 21c, a cushioning member 74 is provided between the high-voltage cable bundle support 112 and the reinforcement member 72.

With the above structure, the pressure of the reinforcement member 72 on the high-voltage cable bundle support 112 and the noise generated by the crash against the high-voltage cable bundle support 112 can be reduced.

Optionally, in one embodiment, as shown in FIGS. 3, 12 and 15a, the low-voltage connection assembly 60 comprises a low-voltage cable bundle 61 and a low-voltage cable bundle support 62. The low-voltage cable bundle 61 is secured on the high-voltage cable bundle support 112 via the low-voltage cable bundle support 62.

With the above structure, the low voltage cable bundle 61 is secured on the high-voltage cable bundle support 112 by the low-voltage cable bundle support 62, thus enabling the high-voltage cable bundle and low-voltage cable bundle to be treated as a whole for easy assembly and management. In addition, it is possible to reduce space occupation and provide space utilization inside the housing 10.

Optionally, in one embodiment, as shown in FIGS. 3, 12 and 15a, the battery module 20 comprises a battery module 20L and a battery module 20R. A gap S is provided between the battery module 20L and the battery module 20R. The low-voltage connection assembly 60 is provided in the gap S. The battery pack 100 further comprises a control means 41. The control means 41 is provided in the gap S, located between the control means 41 and the battery module 20R and located below the control means 41.

With the above structure, the control means 41 is provided in the gap S between the battery module 20L and the battery module 20R, and thus the gap S between the battery module 20L and the battery module 20R is used to provide the control means 41, which enables a compact structure of the battery pack 100 and facilitates miniaturization of the battery pack 100, thereby increasing the energy density of the battery pack 100, and also facilitating assembly. In addition, for example, the height position of the control means 41 can be decreased compared to the structure in which the control means 41 is provided over the battery module, so that the height dimension of the housing 10 of the battery pack 100 is smaller in the part where the control means 41 is received, thereby facilitating the miniaturization of the battery pack 100.

In addition, with the above structure, the low-voltage connection assembly 60 and the control means 41 are arranged together in the gap S between the battery module 20L and the battery module 20R, which can further make the structure compact and facilitate the miniaturization of the battery pack 100.

Furthermore, in the gap S, the low-voltage connection assembly 60 is positioned between the control means 41 and the battery module 20R, i.e., the low-voltage connection assembly 60 and the control means 41 are configured misaligned when viewed in the up-down direction, thus allowing the operator to easily operate both the control means 41 and the low-voltage connection assembly 60, avoiding mutual interference between the operations of the two.

In addition, the low-voltage connection assembly 60 is positioned below the control means 41, thus enabling stable positioning and reliable performance of the low-voltage connection assembly 60.

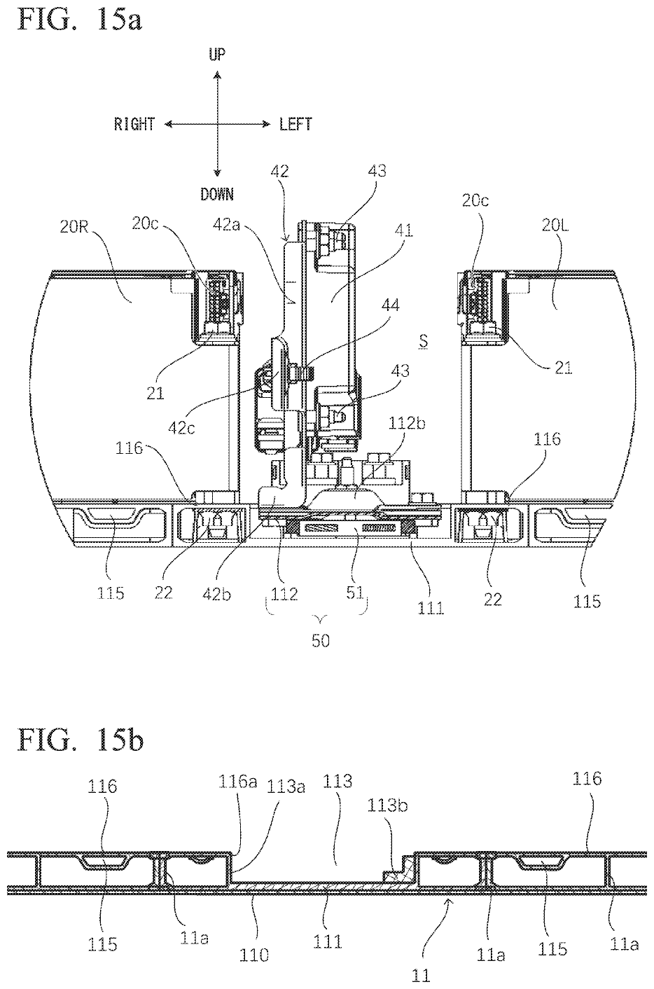

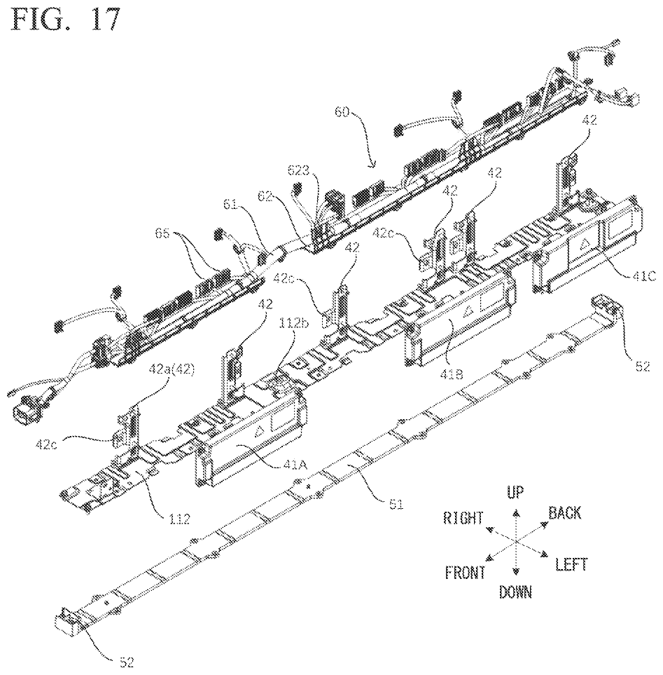

Optionally, in one embodiment, as shown in FIGS. 15a and 17, the control means 41 is secured on the base plate 11 via the control means support 42. The control means 41 support comprises a main part 42a and a base part 42b. The main part 42a is configured vertically with respect to the base plate 11, holding the control means 41. The base part 42b is bent from the lower end of the main part 42a and mounted on the base plate 11.

With the above structure, the control means 41 support is formed into an L-shaped support, and the upper part of the L-shaped support occupies less space, which improves the space utilization inside the battery pack 100, and achieves a solid and reliable connection at the bottom.

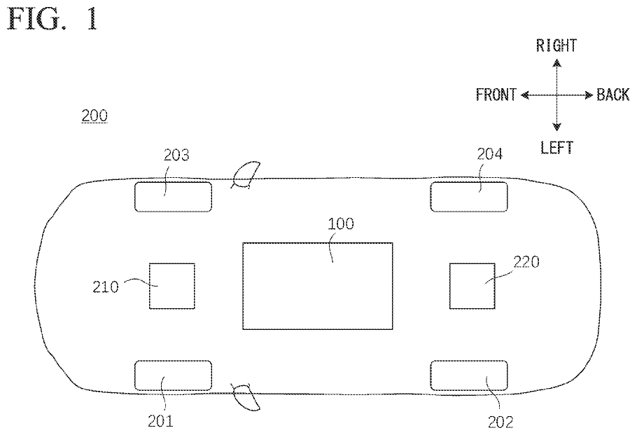

As shown in FIG. 1, in embodiments of the present invention, provided also is a vehicle 200 comprising a battery pack 100.

With the vehicle 200, the same technical performance can be obtained as with battery pack 100, which is not repeated here.

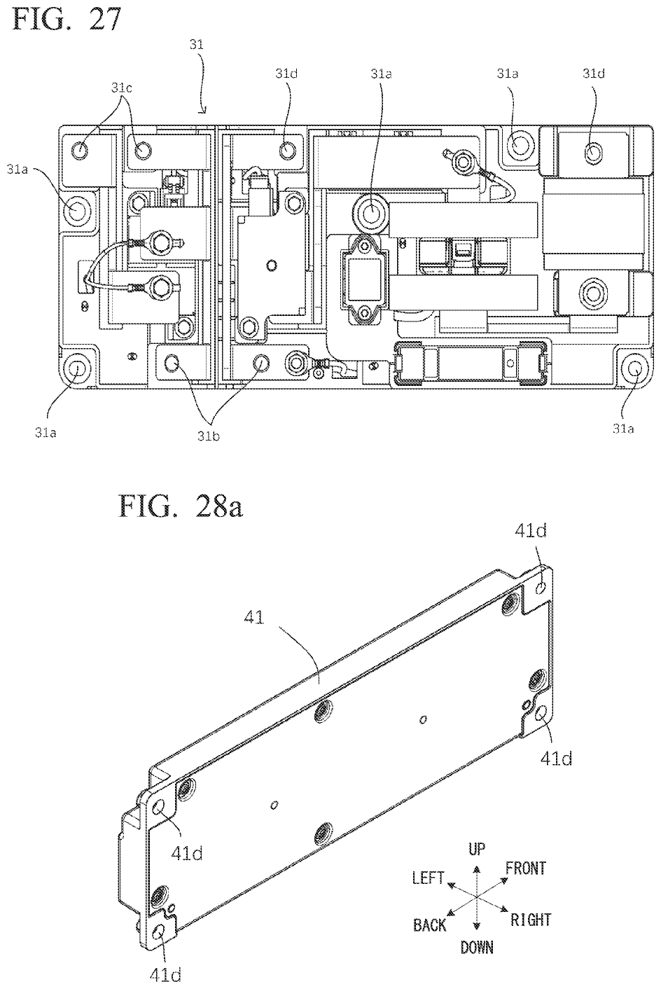

FIGS. 1 to 29 illustrate an embodiment of the present invention, which is described in detail below.

<Vehicle>

FIG. 1 is a schematic diagram of a vehicle related to one embodiment of the present invention. As shown in FIG. 1, vehicle 200 is an electric vehicle comprising a battery pack 100, motors 210 and 220, and wheels 201 to 204. The battery pack 100 supplies electrical energy to the motors 210 and 220. The motor 210 is configured at the front of the vehicle 200, in front of the battery pack 100, and is used to drive the two front wheels 201 and 203. The motor 220 is located at the rear of the vehicle 200, behind the battery pack 100, and is used to drive the two back wheels 202 and 204. When the driver is driving manually or the vehicle 200 is driving automatically, the battery pack 100 supplies power to the motor 210 and/or the motor 220 which drives the wheels 201 and 203 and/or the wheels 202 and 204 to move the vehicle 200 forward or backward.

There are no special restrictions on the type of the vehicle 200, for example, it can be a car, a truck, a passenger bus or a sport utility vehicle (SUV), etc.

In addition, the vehicle 200 shown in FIG. 1 is a purely electric vehicle. However, the present invention is not limited to this and can also be applied in hybrid vehicles.

Further, in the vehicle 200 illustrated in FIG. 1, the two motors 210 and 220 are included at the front and rear, however, the number and configuration of motors in the present invention is not limited to this, for example, four hub motors or wheel side motors may be included, or three motors may be included, etc. When three motors are included, there may be, for example, one motor at the front of the vehicle 200 and two motors at the rear of the vehicle 200.

<Battery Pack as a Whole>

FIG. 2 is a schematic diagram of the principle of a battery pack related to an embodiment of the present invention. As shown in FIG. 2, the battery pack 100 includes a housing 10, battery modules 20L and 20R, high-voltage connection assemblies 50 and 55, and a power distribution unit 31. The housing 10 accommodates the battery modules 20L and 20R, with the battery module 20L configured in the left side area of the housing 10 and the battery module 20R configured in the right side area of the housing 10. Furthermore, the battery modules 20L and 20R are spaced apart in the left-right direction, and a gap S is provided between them so that the housing 10 has an intermediate area between the left area where the battery module 20R is configured and the right area where the battery module 20R is configured. In this document, the letters L and R in the reference symbols “20L and 20R” indicate left and right, respectively, and when no distinction is made between left and right, they are referred to as battery module 20.

The power distribution unit 31 is used to be responsible for transferring or transmitting electrical energy from the battery pack 100 to other high voltage systems such as the motors 210 and 220 or an air conditioning compressor (not shown), etc.

In addition, as shown in FIG. 2, the connector 52 and the connector 53 are provided at the front and rear portions of the housing 10, respectively. All of the battery modules 20 are connected in series and then are electrically connected to the power distribution unit 31. The power distribution unit 31 is electrically connected to the connector 52 at the front via the high voltage connection assembly 50. The front connector 52 is used to electrically connect to the motor 210 at the front. In addition, the power distribution unit 31 is electrically connected to the connector 53 at the rear via the high voltage connection assembly 55. The connector 53 is used to electrically connect to the motor 220 at the rear.

Here, the electrical connection between the connectors 52 and 53 and the motors 210 and 220 may be a direct electrical connection or an indirect electrical connection. For example, the electrical connection can be made via an on-board AC/DC power charger, an on-board DC/DC power converter, a vehicle high voltage connection hub, etc. In addition, the voltage of the high-voltage connection assemblies 50 and 55 is, for example, 400 V, 500 V, etc.

In addition, as shown in FIG. 2, in this embodiment, the high voltage connection assembly 50 extends from the vicinity of the power distribution unit 31 via the aforementioned intermediate area of the housing 10 towards the front to the vicinity of the connector 52. This will be described in more detail later.

FIG. 3 is a schematic diagram of a structure of a battery pack 100, showing a partial structure near the central portion in the left-right direction. As shown in FIG. 3, the battery pack 100 also includes a plurality of control means 41 and a low-voltage connection assembly 60 of the battery management system (BMS). the plurality of control means 41 are used to intelligently manage and maintain the individual battery modules 20L, 20R, to prevent overcharging and overdischarging, to extend the service life, and to monitor the battery status, etc. The low-voltage connection assembly 60 is used to electrically connect the control means 41 to the battery modules 20L and 20R. The voltage of the low-voltage cable bundle 61 is, for example, 12 V.

In addition, both the high voltage connection assembly 50 and the low voltage connection assembly 60 are electrical connection assemblies in this application.

The structure of each component of the battery pack 100 will be described in detail below.

<Housing>

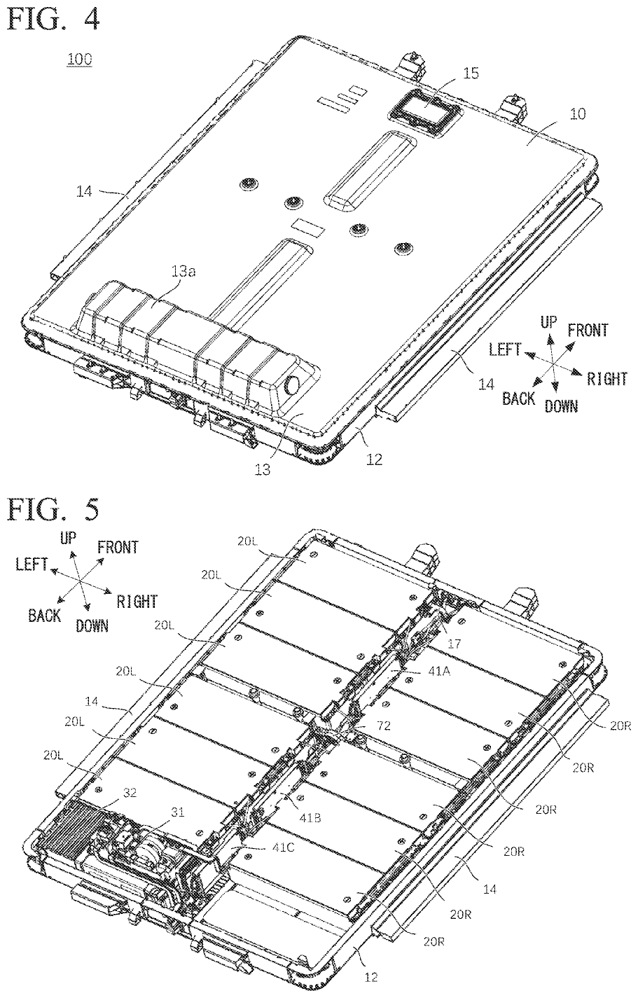

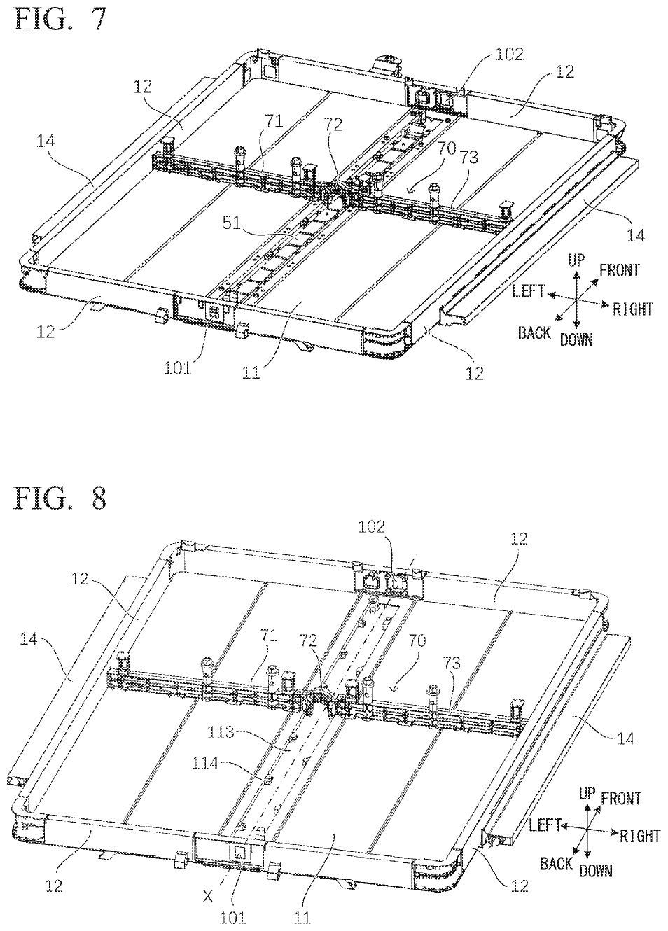

FIG. 4 is a schematic diagram of the structure of a battery pack; FIG. 5 is a schematic diagram of the three-dimensional structure of the battery pack of FIG. 4 in a state with the top cover removed; FIG. 6 is a schematic diagram of the structure of the battery pack of FIG. 4 in a top view with the top cover removed; FIG. 7 is a schematic diagram of a portion of the structure of the housing of the battery pack of FIG. 4; and FIG. 8 is a schematic diagram of the structure in FIG. 7 in a state with the high-voltage cable bundle removed.

As shown in FIGS. 4, 7 and 8, the housing 10 of the battery pack 100 has an overall flat rectangular shape and includes a base plate 11, side plates 12, a top cover 13, and lugs 14. The base plate 11 is substantially rectangular in shape with the length direction thereof aligning with the front-back direction. In this embodiment, the base plate 11 has a center line X extending in the front-back direction and is substantially left-right symmetrical in shape with respect to the center line X. In addition, in this embodiment, the center line X is also the center line of the housing 10, which means that the housing 10 is also substantially left-right symmetrical in shape. The top cover 13 is approximately the same rectangular shape as the base plate 11 and is configured opposite to the base plate 11 vertically. The side plates 12 extend upward from the peripheral edges of the base plate 11 to the top cover 13. The base plate 11, the top cover 13, and the side plate 12 together form a space that can accommodate a plurality of battery modules 20. In this embodiment, the side plate 12 is secured on the base plate 11 and the top cover 13 is mounted on the side plate 12 in a removable manner. It is understood that the shape of the battery pack 100 and the like herein are merely an illustration and do not constitute a limitation of the present invention.

As shown in FIGS. 4, 5 and 6, lugs 14 protrude from the outer wall surface of the side plate 12. By means of the lugs 14, the housing 10 and the battery pack 100 are mounted on the bodywork of the vehicle 200.

In addition, as shown in FIG. 4, a window plate 15 is mounted at the front of the top cover 13 and at the center in the left-right direction. The window portion (not shown) on the top cover 13 is opened by removing the window plate 15, so that the interior of the housing 10 can be seen. Before disassembling the battery pack 100 for maintenance, etc., the window plate 15 can be opened to disconnect the high-voltage circuit, and then the entire battery pack 100 can be disassembled, thus ensuring safe operation, etc.

In addition, as shown in FIG. 8, a reinforcement assembly 70 is provided in the housing 10, as shown in FIG. 15b, etc., and the bottom plate 11 is provided with a receiving section 113 and a coolant channel 115, etc. These structures will be described in detail later.

Further, as shown in FIGS. 7 and 8, the front portion and the rear portion of the housing 10 are provided with a connection port 102 and a connection port 101, respectively, with the connection port 102 being used to configure a connector 52 (FIG. 2) to be able to connect the motor 210 at the front. The connection port 101 is used to configure the connector 53 (FIG. 2) to be able to connect the motor 220 at the rear. In this embodiment, the connection port 101 and the connection port 102 are located on the side plate 12. In other embodiments, they can also be located on the top cover 13 or on the bottom plate 11. Further, in this embodiment, the connection port 101 and the connection port 102 are configured in the central part of the housing 10 in the left-right direction. In other embodiments, the connection port 101 and the connection port 102 can also be provided in other positions.

<Battery Modules and Related Structures>

As shown in FIGS. 2, 3, 5 and 6, there are a plurality of battery modules 20L and battery modules 20R arranged on the base plate 11 (specifically, the plate 116) in a front-back direction. Also, the battery module 20L and the battery module 20R have a gap S between them in the left-right direction. In addition, each battery module 20L and 20R has a rectangular shape with its height direction aligned with the up-down direction, its short side direction aligned with the front-back direction, and its long side direction aligned with the left-right direction. In other words, the plurality of battery modules 20L and the plurality of battery modules 20R are each arranged in such a way that the long sides are adjacent to each other and the short sides are aligned.

In addition, as shown in FIGS. 2 and 5, the positive and negative terminals of each battery module 20 are located at the two ends in the left-right direction, respectively. Also, in the plurality of battery modules 20L on the left side and the plurality of battery modules 20R on the right side, the positive and negative terminals of adjacent battery modules 20 are configured opposite to each other. That is, for example, if one left battery module 20L (or right battery module 20R) has the positive terminal at the left end and the negative terminal at the right end, then another left battery module 20L (or right battery module 20R) adjacent to that left battery module 20L has the positive terminal at the right end and the negative terminal at the left end. In this way, the length of the cables between the battery modules can be shortened by referring to the cables between the adjacent left battery modules 20L (or right battery modules 20R) in FIG. 2.

Alternatively, between the plurality of battery modules 20L and the plurality of battery modules 20R, the positive and negative terminals of the adjacent or correctly opposed battery modules 20 are configured opposite each other. That is, for example, if a left battery module 20L has a positive terminal at the left end and a negative terminal at the right end, then a right battery module 20R adjacent to that left battery module 20L, or right-opposed to that left battery module 20L, also has a positive terminal at the left end and a negative terminal at the right end. Thus, for example, the cable length between the battery modules 20L and 20R can be shortened by referring to the cables between the two foremost battery modules 20L and 20R in FIG. 2.

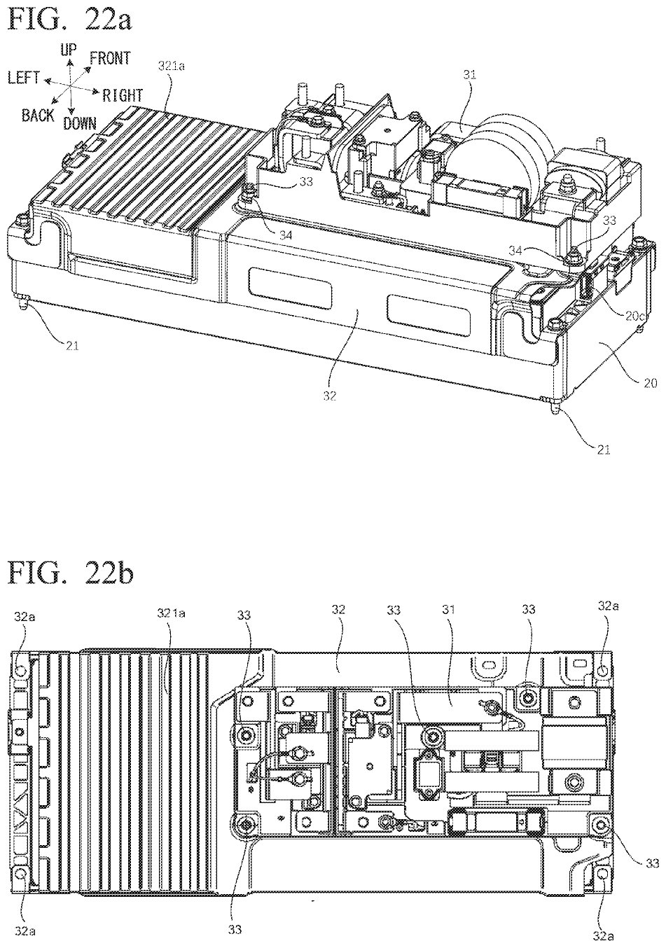

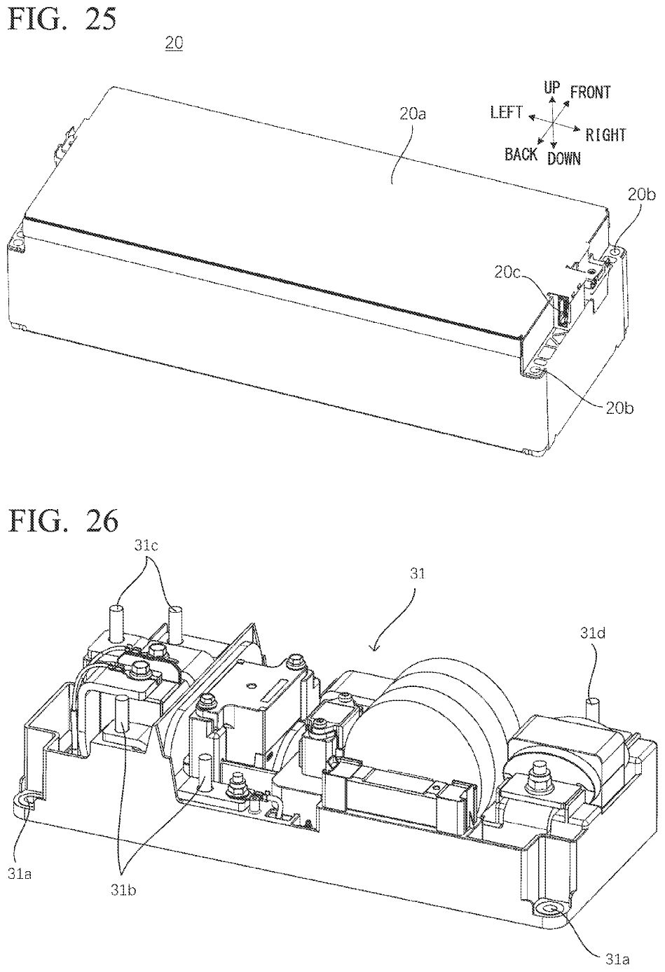

FIG. 25 is a schematic diagram of the three-dimensional structure of a battery module related to this embodiment. In addition, FIG. 25 shows a battery module 20L on the left side, but the battery module 20R on the right side has the same structure except that it is configured in a different direction. As shown in FIG. 25, the battery module 20 is roughly rectangular in shape, with the long side in the left-right direction and the short side in the front-back direction, and the height direction is consistent with the up-down direction. The battery module 20 has a main body 20a with a plurality of mounting holes 20b. By passing a plurality of bolts 21 (FIGS. 22a and 15a) through each of the mounting holes 20b, the battery module 20 can be secured on the base plate 11 of the housing 10.

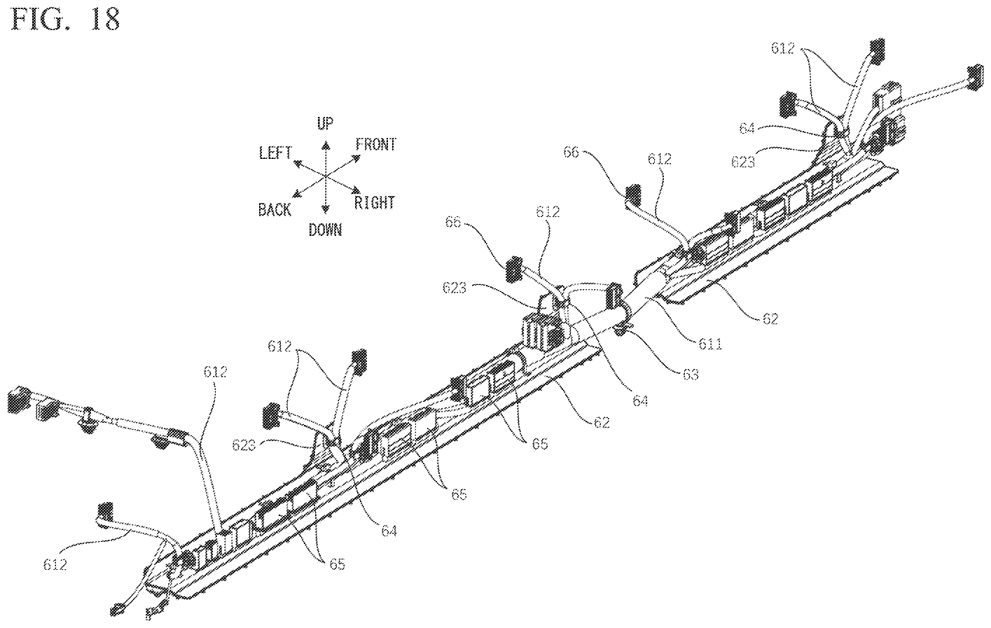

In addition, as shown in this FIGS. 25 and 15a, a lead port 20c is provided on one of the left and right ends of the main body 20a for electrically connecting the connector 66 of the low-voltage connection assembly 60 (FIGS. 18 to 20), which in turn electrically connects the control means 41 (FIG. 15, etc.). In this embodiment, as shown in FIG. 25, in case the battery module is the battery module 20L on the left side, the lead port 20c is located at the right end of the battery module 20L, and in the case the battery module is the battery module 20R on the right side, the lead port 20c is located at the left end of the battery module 20R. In other words, the lead port 20c is located at the end of the battery module 20 close to the center, and close to the gap S between the left-hand battery module 20L and the right-hand battery module 20R. In this way, since the control means 41 is located in the gap S, it is possible to configure the lead port 20c close to the control means 41 and shorten the cable length between the control means 41 and the battery module 20.

As shown in FIGS. 5 and 6, a jumper support 17 is provided between the two frontmost battery modules 20L, 20R. The jumper support 17 is bridge-shaped and protrudes upward into an arch shape, with one end connected to the left battery module 20L and the other end connected to the right battery module 20R. The jumper support 17 is shaded near the top of the terminal block 58 that will be described below, and the window plate 15 described above covers the top of the jumper support 17. The jumper support 17 acts as a switch (a manually maintaining switch) for the high voltage system circuit inside the battery pack 100. Before disassembling the battery pack 100 for maintenance, etc., the window plate 15 can be opened and then the jumper support 17 can be removed so that the high voltage circuit cannot generate conduction and is disconnected, thus allowing safe maintenance work to be performed on the high voltage system.

The battery module 20 may include a plurality of battery cores (single cores) which may be housed within a rectangular shaped battery module housing arranged in the direction of the long side of the battery module housing. It is apparent that the number of battery cores does not constitute a limitation to the present invention, and even if the battery module 20 has only one battery core, it does not affect the implementation of the present invention.

<High-Voltage Connection Assembly and Related Structures>

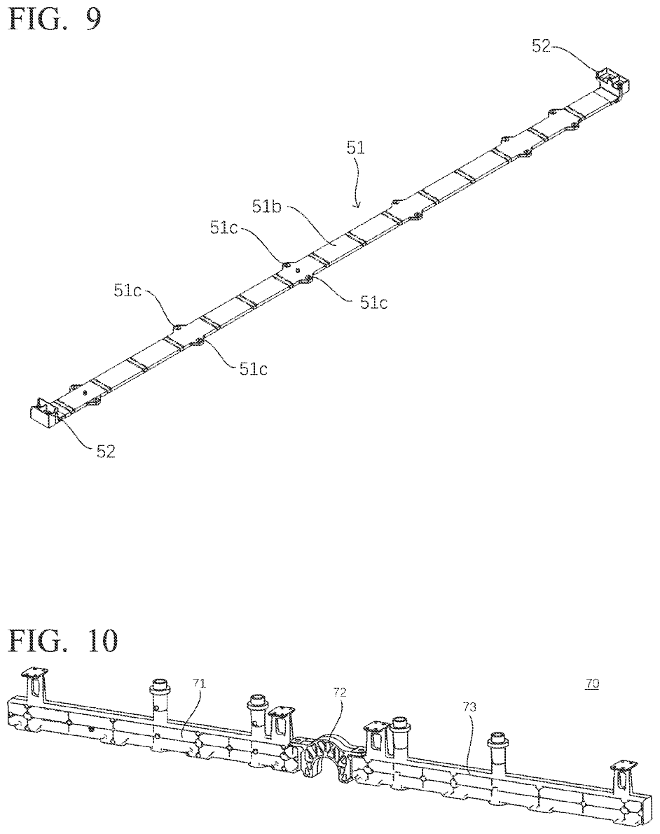

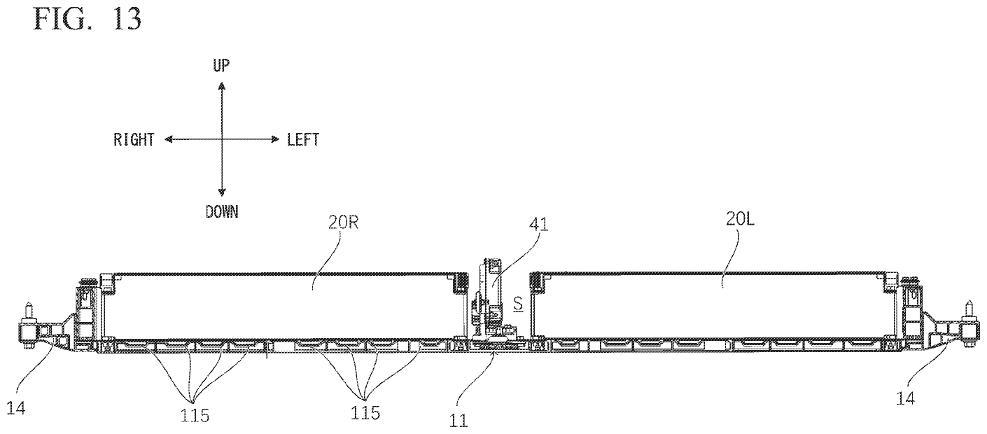

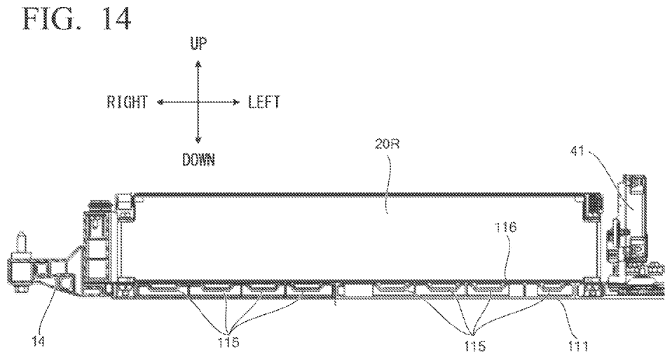

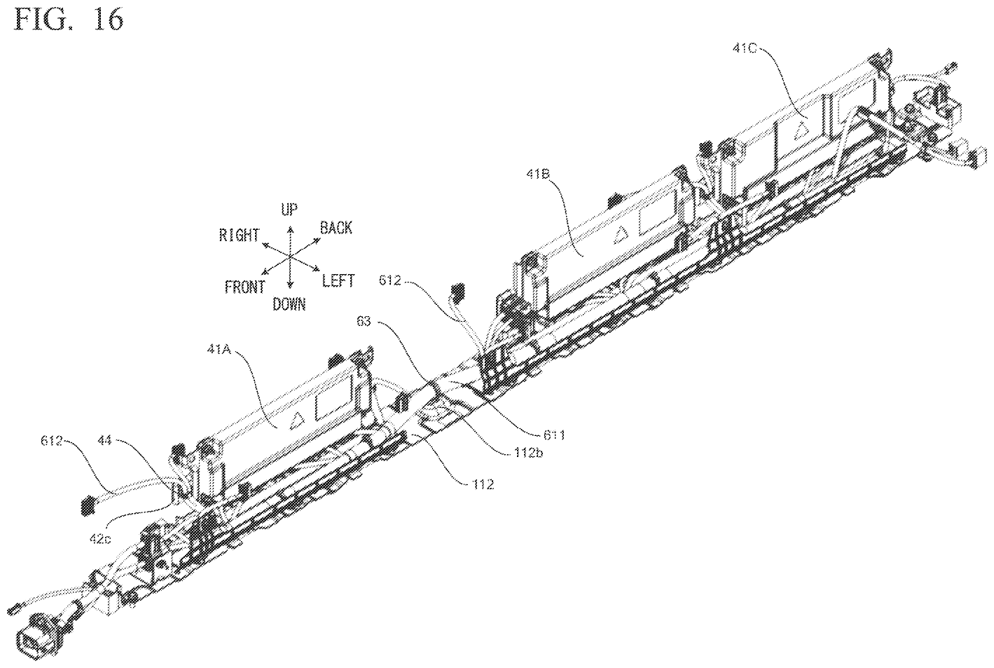

FIG. 9 is a schematic diagram of the structure of the high-voltage cable bundle related to this embodiment; FIG. 11 is a cross-sectional schematic view of the structure in FIG. 6; FIG. 12 is a partially enlarged view of the structure in FIG. 11; FIG. 13 is another cross-sectional schematic view of the structure in FIG. 6; FIG. 14 is a partially enlarged view of the structure in FIG. 13; FIG. 15a is another partially enlarged view of the structure in FIG. 13; FIG. 16 is a schematic diagram of the assembled state of the low-voltage connection assembly and control means and its surrounding structures related to this embodiment; FIG. 17 is a schematic diagram of the structure in FIG. 16 in a disassembled state; FIG. 21a is a schematic diagram of the structure of the assembled state of the high-voltage harness support and the control means support related to this embodiment; FIG. 21b is a partially enlarged view of the structure illustrated in FIG. 21a; FIG. 21c is another partially enlarged view of the structure illustrated in FIG. 21a; and FIG. 21d is yet another partially enlarged view of the structure illustrated in FIG. 21a.

As shown in FIGS. 3, 12, 15a, 16 and 17, the high-voltage connection assembly 50 includes a high-voltage cable bundle 51, a terminal block 58 (an example of a connector), and a high-voltage cable bundle support 112. The high-voltage cable bundle 51 is an elongated component for transmitting electrical energy. Two terminal blocks 58 are provided, with each provided at an end of the high-voltage cable bundle 51, one for electrical connection to the power distribution unit 31 and the other for electrical connection to the connector 52 (FIG. 2). The high-voltage cable bundle 51 is mounted on the high-voltage cable bundle support 112, which is mounted on the base plate 11, i.e., the high-voltage cable bundle 51 is mounted on the base plate 11 through the high-voltage cable bundle support 112.

It is understood that the “cable bundle” may be made of multiple wires, or it may be made of a single wire.

As shown in FIGS. 2, 3, 9, 12 and 15a, the high-voltage cable bundle 51 has a flat shape in a cross section, specifically in this embodiment, a substantially flat rectangular cross section. Here, the cross section is the cross section perpendicular to the cable length direction of the high-voltage cable bundle 51; “flat” means that the size in one dimension is smaller than the size in another dimension, for example, in the state in FIG. 12, the height of the high-voltage cable bundle 51 (the size in the up-down direction) is smaller than the width size (the size in the left-right direction). Thus, the height direction of the high-voltage cable bundle 51 is also the thickness direction. It will be appreciated that a flat cable can be reduced in size in one direction compared to a round cable or a square cable with the same electrical conductivity. For example, referring to the round low-voltage cable bundle 61 and the flat high-voltage cable bundle 51 shown in FIG. 12, the size of the high-voltage cable bundle 51 is significantly smaller in the up-down direction than the low-voltage cable bundle 61. Also, it should perhaps be noted that the comparison between the low-voltage cable bundle 61 and the high-voltage cable bundle 51 is intended to illustrate the characteristics of the flat high-voltage cable bundle 51 and does not imply that the conductivity of the low-voltage cable bundle 61 and the high-voltage cable bundle 51 need to be the same.

Referring to FIGS. 3 and 12, the high-voltage cable bundle 51 includes a conductive member 51a and a covering layer 51b covering the conductive member 51a. The conductive member 51a is made of a metal, and as an example of its material, copper may be used, i.e., the conductive member 51a is a copper bar. It goes without saying that other conductive materials can be used for the conductive member 51a. As an example, the covering layer 51b is an insulating layer, which can be made of a plastic. It goes without saying that other materials, such as rubber, can be used for the covering layer 51b.

Furthermore, in this embodiment, there are two conductive members 51a, each of which is covered by a covering layer 51b, so that a short circuit between the two conductive members 51a is reliably avoided by the covering layer 51b. Furthermore, in this embodiment, the conductive member 51a has a substantially rectangular cross section and the covering layer 51b has a substantially flat rectangular cross section, with the long sides of the rectangles of the two oriented parallel to each other and the short sides oriented parallel to each other.

As shown in FIGS. 3, 12 and 15a, a receiving section 113 is provided on the base plate 11, and the high-voltage connection assembly 50 is configured in the receiving section 113.

As shown in FIGS. 3, 12, 15a, and 15b, the base plate 11 of the housing 10 includes a plate 111 and a plate 116, the plate 111 and the plate 116 are configured opposite each other vertically and spaced apart, the plate 116 is located over the plate 111, and the battery module 20 is located over the plate 116. The receiving section 113 is configured in the up-down direction within a height range between the plate 111 and the plate 116.

Thus, for example, when the vehicle is subjected to a lateral collision, the battery pack 100 is deformed and the battery module 20 moves horizontally. However, the high-voltage connection assembly 50 is configured in the base plate 11 below the battery module 20. As a result, the battery module 20 does not easily impact the high-voltage connection assembly 50, thereby inhibiting the occurrence of problems such as deformation, breakage, fracture, leakage, and damage to the electrical connection (including poor contact or electrical connection failure) of the high-voltage connection assembly 50, thereby improving the safety and reliability of the battery pack 100.

In this embodiment, the base plate 11 and the plates 111 and 116 are configured horizontally with their extension direction substantially in the horizontal direction and their thickness direction substantially in the up-down direction.

In addition, as shown in FIGS. 11, 13 and 14, in this embodiment, a plurality of coolant channels 115 are formed between the plate 111 and the plate 116. That is, the receiving sections 113 are located between the plate 111 and the plate 116 along with the coolant channels 115, so that the coolant channels 115 can be easily used to cool the high voltage connection assembly 50 (high voltage cable bundle 51).

Furthermore, the coolant channels 115 are configured directly below the battery modules 20L and 20R, and the coolant channels 115 overlap with the battery module 20L or battery module 20R when viewed in the up-down direction. That is, the coolant channels 115 are configured in the horizontal direction opposite the battery modules 20L and 20R, and are configured close to the battery modules 20L and 20R so that they can effectively cool the battery modules 20L and 20R.

As shown in FIGS. 13 and 15a, etc., the receiving section 113 (and the high-voltage connection assembly 50 therein) is configured in the horizontal direction at a position misaligned with the battery modules 20L and 20R, as viewed in the up-down direction. In this way, it is possible to use the part of the base plate 11 that is not provided with a coolant channel 115 to configure the receiving section 113, effectively utilizing the space of the base plate 11 and making the battery pack 100 more compact and easily miniaturized. On the one hand, affecting the cooling performance of the battery module 20 can be avoided. On the other hand, by keeping the receiving section 113 as far away from the battery modules 20L and 20R as possible, electromagnetic waves from the high-voltage cable bundle 51 can be suppressed from interfering with the battery modules 20L and 20R.

Further, in this embodiment, the battery module 20L is configured in the left side of the base plate 11, the battery module 20R is configured in the right side of the base plate 11, a receiving section 113 is provided in the middle part between the left side and the right side, and the high-voltage connection assembly 50 is configured in the receiving section 113. In other words, in the base plate 11, the receiving section 113 is horizontally configured between the battery module 20L on the left side and the battery module 20R on the right side, opposite the gap S, and coincides with the gap S when viewed in the up-down direction. In this way, it is possible to reduce the impact force on the high-voltage cable bundle 51 during a collision, for example, and suppress damage to the high-voltage cable bundle 51, etc., compared to the position of the receiving section 113 near the outer part of the base plate 11 close to the left and right directions.

Further, as shown in FIGS. 3, 12 and 15a, etc., in this embodiment, the high-voltage cable bundle 51, like the high-voltage connection assembly 50, is also flat in a cross section and is accommodated in the receiving section 113 with its thickness direction substantially consistent with the thickness direction of the base plate 11, i.e., the high-voltage connection assembly 50 and the high-voltage cable bundle 51 are placed flat in the housing 113. In this way, the height of the high-voltage cable bundle 51 can be reduced as much as possible on the basis of ensuring that the high-voltage cable bundle 51 can effectively transmit electrical energy. Thus, it is possible to effectively suppress the impact of the high-voltage cable bundle 51 on the battery module 20 and improve the safety of the battery pack 100. As mentioned above, flat means a shape in which the size in one dimension is smaller than the size in another dimension. On this basis, it is understood that the thickness direction of the flat high-voltage cable bundle 51 is the direction in which the relatively smaller size of the two aforementioned dimensions is located, which in this embodiment is substantially consistent with the up-down direction.

As shown in FIG. 15b, the upper side of the receiving section 113 has an opening 116a, which may also be described as an opening formed in the plate 116. During assembly, the high voltage connection assembly 50 can be placed into the receiving section 113 through this opening 116a. In addition, a carrying part 113b is provided inside the receiving section 113 to carry and secure the high-voltage cable bundle support 112, which in this embodiment is in the form of a step, and the high-voltage cable bundle support 112 is supported by the upper surface of the step. Also, the carrying part 113b can be provided on each of the left and right sides of the receiving section 113. In addition, as shown in FIG. 15b, the housing 10 also includes a plate 110, which covers the bottom of the plate 111 and may, for example, serve as a protection against the plate 111. In addition, in this embodiment, the receiving section 113 is formed as a long slot extending in a front-back direction and has an opening 116a facing upwards.

Additionally, as shown in FIGS. 12, 15a and 17, in this embodiment, the high-voltage cable bundle 51 is mounted from below on the high-voltage cable bundle support 112, which covers the opening 116a and forms the ceiling of the receiving section 113. During assembly, the high-voltage cable bundle 51 can be mounted on the high-voltage cable bundle support 112 first, however, the high-voltage cable bundle support 112 with the high-voltage cable bundle 51 can be mounted on the base plate 11. In this way, the high-voltage cable bundle 51 can be easily mounted and positioned.

Furthermore, in this embodiment, the bottom of the receiving section 113 is formed by a plate 111.

Further, in this embodiment, the receiving section 113 extends from the front end of the base plate 11 to the rear end, and the high-voltage cable bundle support 112, which is long in shape, extends from the front end of the base plate 11 (or the plate 116) to the rear end, covering substantially the entire receiving section in the front-back direction. Thus, the strength of the base plate 11 in the front-back direction can be enhanced by the high-voltage cable bundle support 112. In addition, the high-voltage cable bundle support 112 is long in shape and the high-voltage cable bundle 51 is long in shape, and both are configured to be the same in the length direction, such that the high-voltage connection assembly 50 is also long in shape and extends from the front end of the base plate 11 (or the plate 116) to the rear end.

Further, in this embodiment, the high-voltage cable bundle 51 is secured on the high-voltage cable bundle support 112 by securing the covering layer 51b on the high-voltage cable bundle support 112. In this way, the covering layer 51b both ensures the insulation of the conductive member 51a and secures the conductive member 51a on the high-voltage cable bundle support 112.

As a more specific structure, as shown in FIG. 9, a protrusion 51c is provided on each side surface of the covering layer 51b of the high-voltage cable bundle 51 in the width direction, and the high-voltage cable bundle 51 is secured on the high-voltage cable bundle support 112 by the protrusion 51c. Specifically, for example, a through-hole may be provided in the protrusion 51c through which a rivet or screw 119 (FIG. 21b) passes to secure the high-voltage cable bundle 51 on the high-voltage cable bundle support 112. In addition, the present invention is not limited to this, for example, a bayonet can be provided on the high-voltage cable bundle support 112 so that the protrusions 51c snap into the bayonet, thereby securing the high-voltage cable bundle 51 on the high-voltage cable bundle support 112. In addition, in this embodiment, a plurality of protrusions 51c are provided on each side in the width direction of the covering layer 51b, and the plurality of protrusions 51c are arranged in the length direction of the high-voltage cable bundle 51. In this way, the high-voltage cable bundle 51 is secured on the high-voltage cable bundle support 112 at multiple locations in the length direction, thereby enhancing the bonding strength of the high-voltage cable bundle 51 and the high-voltage cable bundle support 112 and enhancing the strength of the high-voltage connection assembly 50, for example by effectively resisting impact forces from the front-back direction.

Additionally, in this embodiment, the protrusion 51c is integrally formed with the covering layer 51b.

Additionally, the receiving section 113 may pass through the plate 116 in the front-back direction, may not pass through the plate 116, or may pass through one end while not passing through the other end.

As shown in FIGS. 12 and 15a, etc., in this embodiment, the height of the high-voltage cable bundle support 112 is lower than the plate 116, i.e., the high-voltage cable bundle support 112 is lower than the plate 116 in the up-down direction. Additionally, as other embodiments, the height of the high-voltage cable bundle support 112 may be substantially the same as the plate 116, or may also be higher than the plate 116.

In this embodiment, the high-voltage cable bundle support 112 is made of a metal, so that the electromagnetic waves of the high-voltage cable bundle 51 can be shielded, and the electromagnetic waves of the high-voltage cable bundle 51 can be suppressed from interfering with the battery module 20, etc. The high-voltage cable bundle support 112 is, for example, a sheet metal. In other embodiments, the high-voltage cable bundle support 112 can be made of other materials, such as a plastic.

By making the height of the high-voltage cable bundle support 112 lower than or substantially equal to the plate 116, it is possible to reliably suppress the battery module 20 from impacting or crushing the high-voltage connection assembly 50 and the high-voltage cable bundle 51 therein during horizontal movement of the battery module 20.

As shown in FIGS. 3, 12, 15a and 16, etc., a low-voltage connection assembly 60 is provided in the gap S over the high-voltage cable bundle support 112. The low-voltage connection assembly 60 is used to electrically connect the control means 41 to the battery module 20. This enables the low-voltage connection assembly 60 to be configured close to the high-voltage connection assembly 50, enabling a compact structure and efficient use of space, and more efficient use of space in the battery pack 100.

In addition, in this embodiment, a reinforcement assembly 70 is provided transversely above the plate 116, so that the overall strength of the housing 10 can be strengthened, in addition, the configuration of the coolant channels 115 is not affected (the configuration of the coolant channels 115 can be provided without considering the avoidance of the protrusions).

In this embodiment, as shown in FIG. 11, there are a plurality of coolant channels 115, and the plurality of coolant channels 115 are arranged from the middle to the outer portion in the left-right direction as viewed from the front-back direction. Among them, the coolant channel 115a near the outer part is upstream along the liquid flow, and the coolant channel 115b near the middle is downstream along the liquid flow. In other words, in the coolant channels 115, the part farther from the center line X of the base plate 11, i.e., the coolant channel 115a, is downstream along the liquid flow, and the part closer to the center line of the base plate 11, i.e., the coolant channel 115b, is upstream along the liquid flow, and the coolant flows in from the coolant channel 115a and out from the coolant channel 115b. Accordingly, the coolant cools the portion of the battery module 20 close to the outside first, so that the battery module 20 can be cooled well. Specifically, the portion of the battery module 20 close to the outside is more susceptible to external influences. Therefore, in this embodiment, cooling the portion of the battery module 20 close to the outside first can cool the battery module 20 well.

In addition, in this embodiment, one coolant channel 115 is provided near the periphery of the receiving section 113 so that the high voltage connection assembly 50 (high-voltage cable bundle 51) can be effectively cooled.

Additionally, the high voltage connection assembly 50 may be fully housed in the receiving section 113, or partially housed in the receiving section 113. In this embodiment, the high voltage cable bundle 51 is housed as a whole in the receiving section 113, with the terminal blocks 58 at each end partially protruding above the high voltage cable bundle support 112, allowing for easier operation of the cable.

As shown in FIG. 15b, in order to maintain stable spacing between the plate 111 and the plate 116, protrusions 11a may be provided on either or both of them to protrude from one toward the other, and the protrusions 11a may be provided in a plurality. In this embodiment, the plate 111 and the plate 116 are formed separately and assembled together by bolting or welding, etc. In other embodiments, the plate 111 and the plate 116 may also be formed integrally. In this embodiment, the protrusions 11a are formed as long, convex ribs extending in a front-back direction.

As shown in FIGS. 12, 15a, 16, 17 and 21a, the high-voltage cable bundle support 112 includes a main part 112a and a bulging part 112b, with the main part 112a being substantially rectangular in shape and having a substantially horizontal plate orientation so as to cover the opening 116a of the receiving section 113 well. The bulging part 112b bulges upward from the main part 112a and is used to secure the main cable 611 of the low-voltage cable bundle 61 (FIG. 16). This will be described in more detail later.

As shown in FIGS. 8 and 29, a bayonet part 114 is provided on the left and right side wall surfaces 113a (FIG. 15b) of the receiving section 113, which protrudes from the left and right side wall surfaces 113a of the receiving section 113 and has a recess recessed toward the root side (the opening of the recess faces the middle in the left-right direction of the receiving section 113), and the high-voltage cable bundle support 112 is embedded in the recess, thereby limiting the movement in the up-down direction and the left-right direction thereof. In addition, a plurality of bayonet parts 114 are provided on the left and right side walls of the housing 113, arranged in the front-back direction. In this way, the position of the high-voltage cable support 112 can be reliably kept stable.

As shown in FIG. 21b, notch 112c is provided on both edges of the main part 112a in the width direction, the number of notches 112c is the same as that of the bayonet part 114 (FIG. 8) on the base plate 11, and the notch 112c can accommodate the bayonet part 114. When assembling the high voltage cable bundle support 112 on the base plate 11, each notch 112c is first aligned with the bayonet 114 so that the bayonet part 114 enters the notch 112c. In this state, the high-voltage cable bundle support 112 is moved in the front-back direction so that the edge of the main part 112a is inserted into the bayonet part 114, and the bayonet part 114 limits the upward and downward movement of the high-voltage cable bundle support 112.

Further, in this embodiment, in order to easily insert the edge of the main part 112a into the bayonet part 114, the opening range of the bayonet part 114 (i.e., the opening size in the up-down direction) is greater than the thickness of the main part 112a, for example, 1.5 times or more than 2 times the thickness of the main part 112a.

In addition, as a modification, only one of the left and right side wall surfaces can be provided with a bayonet part 114.

As shown in FIG. 21d, a positioning part 112d is provided at the edge in the width direction of the main part 112a, and the positioning part 112d has an edge 112d1 and an edge 112d2, with the edge 112d1 extending in a straight line in the length direction of the main part 112a and the edge 112d2 extending in a straight line in the width direction of the main part 112a. The base plate 11 of the housing 10 is provided with a positioning portion (not shown) that fits the positioning portion 112d, and the positioning part on the base plate 11 matches the shape of the positioning part 112d so that the high-voltage cable bundle support 112 can be positioned in the front-back direction and the left-right direction.

As shown in FIGS. 21b and 21d, a plurality of mounting holes (not shown) are provided in the main part 112a, and by mounting bolts 117 in these mounting holes, the high-voltage cable bundle support 112 can be secured on the base plate 11. In addition, in this embodiment, mounting holes are provided at the front and rear ends of the main part 112a.

When mounting the high-voltage cable bundle support 112, each notch 112c is aligned with the bayonet part 114, and then the high-voltage cable bundle support 112 is moved slightly downward so that the bayonet part 114 enters the notch 112c. In this state, the high-voltage cable bundle support 112 is moved in the front-back direction so that the positioning part 112d on the main part 112a is abutted against the positioning part on the base plate 11 in the front-back direction, and then the high-voltage cable bundle support 112 is adjusted so that the positioning part 112d is abutted against the positioning part on the base plate 11 in the left-right direction, thereby achieving the positioning of the high-voltage cable bundle support 112 in the front-back direction and the left-right direction. At the same time, the left and right edges of the main part 112a are inserted into the bayonet part 114 of the base plate 11, so that the movement of the high-voltage cable bundle support 112 in the up-down direction is limited by the bayonet part 114. In this state, the bolts 117 are inserted through the mounting holes in the main part 112a to secure the high-voltage cable bundle support 112 on the base plate 11.

As shown in FIG. 21c, a cushioning member 74 may be placed on each of the left and right sides of the main part 112a at the bulging part 112b, and the cushioning member 74 is clamped by the main part 112a and the reinforcement member 72 of the reinforcement assembly 70 that will be described later (FIG. 12), for cushioning the pressure of the reinforcement assembly 70 or reinforcement member 72 on the high-voltage cable bundle support 112. The material of the cushioning part 74 is not particularly limited and can be, for example, a metal, rubber, plastic or felt.

In this embodiment, the high-voltage cable bundle support 112 is secured on the high-voltage cable bundle 51, thereby enabling enhanced strength of the base plate 11 in the front-back direction. In addition, the flat high-voltage cable bundle 51 is secured while overlapping the plate-shaped high-voltage cable bundle support 112, which can further enhance the strength.

<Power Distribution Unit and Related Structures>

As shown in FIGS. 2, 5, and 6, the power distribution unit 31 is mounted in the housing 10.

As described above, the power distribution unit 31 is used to transfer or transmit electrical energy from the battery pack 100 to other high voltage systems such as the motors 210 and 220 or an air conditioning compressor (not shown), etc. In this embodiment, as shown in FIGS. 2, 5 and 6, etc., the power distribution unit 31 is configured on the rearmost battery module 20L of the plurality of battery modules 20L. The power distribution unit 31 may include a relay, a current sensor, a fuse, a pre-charge resistor, etc., wherein the relay may be considered as a high current switch that cuts off the current flowing through the busbar and electrically isolates the high voltage battery from the rest of the high voltage system. The current sensor is used to detect the current flowing through the circuit. The pre-charge resistor is used to protect the system from damage caused by electrical surge power.

In this embodiment, the power distribution unit 31 is mounted at the rear inside the housing 10. In this way, maintenance and replacement of the power distribution unit 31 can be carried out easily compared to mounting the power distribution unit 31 in the middle.

Further, as shown in FIG. 2, a connector 53 is provided at the rear of the housing 10, and the power distribution unit 31 is configured at the rear of the housing 10 near the connector 53, allowing the cable length between the power distribution unit 31 and the connector 53 to be shorter and to be easily wired. Specifically, due to the proximity of the power distribution unit 31 to the connector 53, the high-voltage connection assembly 50 connecting the power distribution unit 31 to the connector 53 is shorter, and thus can be less susceptible to impact or squeezing by the battery module 20 without being set in the base plate 11. In this way, the complex assembly operation configured in the base plate 11 can be performed for only one of the high-voltage connection assembly 50 and the high-voltage connection assembly 55, and without the complex assembly operation configured in the base plate 11 for the other one, thus enabling easy wiring and reducing assembly time.

As shown in FIG. 4, a protrusion 13a is provided on the upper surface of the rear of the top cover 13 of the housing 10, and the inner side of the protrusion 13a is a concave part for accommodating the power distribution unit 31. In this embodiment, the power distribution unit 31 is configured near the connector 53 so that the protrusion 13a accommodating the power distribution unit 31 is arranged at the rear of the housing 10, so as to have no larger protrusion at the front of the housing 10 of the battery pack 100, thereby allowing more space in the vehicle cabin corresponding to the location of the battery pack 100 to accommodate the feet of the passengers.

Additionally, the power distribution unit 31 is mounted on the battery module 20 from above. In this way, it is possible to reduce the size of the gap S, reduce the size of the battery pack 100 in the left-right direction, and increase the energy density of the battery pack 100 compared to configuring the power distribution unit 31 in the gap S.

In addition, the power distribution unit 31 is mounted on a single battery module 20. In this way, it is possible to improve the ease of assembly of the power distribution unit 31 and also improve the stability of the power distribution unit and reduce the overall space occupied by the power distribution unit 31 as compared to the power distribution unit 31 being connected across two or more battery modules 20.

In this embodiment, the power distribution unit 31 is mounted on a single battery module 20L, and that battery module 20L on which the power distribution unit 31 is mounted is the rearmost of the plurality of battery modules 20L. Also, as other embodiments, the power distribution unit 31 is not limited to the rearmost battery module 20L, but may also be configured on other battery modules 20 at the rear. Further, as other embodiments, the power distribution unit 31 may also be mounted on the battery module 20R.

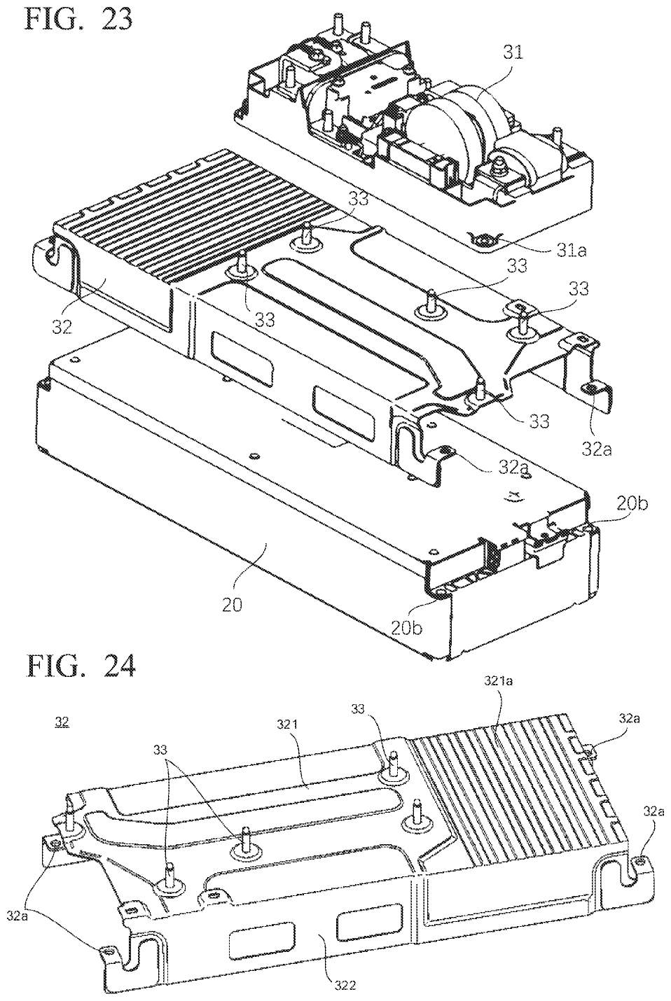

FIG. 22a is a schematic diagram of a three-dimensional structure of an assembled state of a battery module, a power distribution unit support and a power distribution unit related to this embodiment; FIG. 22b is a top schematic view of the structure in FIG. 22a; FIG. 23 is a schematic structural view of the structure of FIG. 22a in a disassembled state; and FIG. 24 is a schematic diagram of the three-dimensional structure of a power distribution unit support related to one embodiment.

As shown in FIGS. 22a and 22b, the power distribution unit 31 is mounted on the battery module 20L by the power distribution unit support 32. In this way, a special support is provided to mount the power distribution unit 31, which can improve the stability of the power distribution unit.

As shown in FIGS. 22a and 24, the power distribution unit support 32 includes a top 321 and a side 322. The top 321 is substantially plate-shaped and is used to cover the upper surface of the battery module 20. The side 322 has two portions extending downward from the front and rear ends of the top 321 to cover the side surfaces of the battery module 20, respectively. By forming such a shape, the top 321 of the distribution unit support 32 plies-up the upper surface of the battery module 20 and the side 322 plies-up the side surfaces of the battery module 20, thereby, on the one hand, enhancing the connection strength and keeping the power distribution unit 31 in a stable position, and on the other hand, enabling the compact structure of the power distribution unit support 32 and the battery module 20, avoiding the excessive size of the distribution unit support 32, reducing the occupied space, and facilitating the miniaturization of the battery pack 100.

As other embodiments, only one side 322 may be provided.

Additionally, a plurality of mounting holes 32aare provided in the side 322 for mounting the power distribution unit support 32 on the battery module 20.

More specifically, as shown in FIGS. 23 and 25, a plurality of mounting holes 20b are provided in the battery module 20, and as shown in FIGS. 15a and 22a, the bolts 21 are passed through the mounting holes 32a and 20b in sequence and screwed into the nuts 22 provided in the base plate 11, so that the structure (the bolts 21 and the nuts 22) for mounting the battery module 20 on the base plate 11 can be used to mount the power distribution unit support 32 on the battery module 20, thereby simplifying the structure and reducing the manufacturing cost, without placing a mounting structure on the battery module 20 separately.

In this embodiment, the mounting hole 32a is located above the mounting hole 20b, however, in other embodiments, the mounting hole 32a may also be located below the mounting hole 20b, i.e., the part of the power distribution unit support 32 with the mounting hole 32a is inserted between the battery module 20 and the base plate 11. It can be seen that “the bolt 21 passes through the mounting hole 32a and the mounting hole 20b in sequence” is not limited to the bolt 21 passing through the mounting hole 32aand then the mounting hole 20b, but means that the bolt 21 passes through one of the mounting hole 32a and the mounting hole 20band then the other.

Further, as shown in FIGS. 22a, 22b, 23 and 24, a plurality of bolts 33 are provided on the upper surface of the top 321 of the power distribution unit support 32 for mounting the power distribution unit 31 on the power distribution unit support 32. Specifically, by passing the bolts 33 through the mounting holes 31a in the power distribution unit 31 and screwing the nuts 34 on the portion that has passed through, the distribution unit can be mounted on the power distribution unit support 32.

As shown in FIGS. 22a and 26, lead terminals 31b, 31c, and 31d are provided on the power distribution unit 31, and there are two of each of the lead terminals 31b, 31c, and 31d. The lead terminals 31b are used to electrically connect the connector 53 at the rear through the high-voltage connection assembly 55 so as to electrically connect the motor 220 at the rear; the lead terminals 31c are used to electrically connect a series connected battery module 20; and the lead terminals 31d are used to electrically connect the connector 52 at the front through the high-voltage connection assembly 50 so as to electrically connect the motor 210 at the front.

As shown in FIG. 22b, the front-back and left-right dimensions of the power distribution unit support 32 are substantially the same as those of the battery module 20, and the front-back and left-right dimensions of the power distribution unit 31 are smaller than those of the power distribution unit support 32 and the battery module 20. In this way, the mounting points of the power distribution unit support 32 can be better arranged so that the power distribution unit support is more stably secured above the battery module.

As shown in FIGS. 22a and 22b, the power distribution unit 31 is configured in the left-right direction near the right end of the power distribution unit support 32, that is, near the center in the left-right direction of the housing 10 or the base plate 11. In this way, it is possible to shorten the cable length between the power distribution unit 31 and the connector 53, or between the power distribution unit 31 and the high-voltage cable bundle 51, thereby saving costs and facilitating wiring.

More specifically, one or more bolts 33 for mounting the power distribution unit 31 are provided at the right end of the power distribution unit support 32, so that the power distribution unit 31 can be configured at the right end of the power distribution unit support 32 in the left-right direction.

In addition, in this embodiment, the bolts 33 are secured on the upper surface of the power distribution unit support 32 by welding or a one-piece molding, etc., and the mounting of the power distribution unit 31 is implemented by screwing in the nuts 34 from the side of the power distribution unit 31. In this way, there is no need to leave space for providing nuts 34, etc. on the lower surface side of the top 321 of the power distribution unit support 32, so that the top 321 can ply-up the battery module 20 well, which helps to improve the stability of the power distribution unit support 32 and reduce the space occupied by the power distribution unit support 32.

Further, as shown in FIGS. 22a, 22b and 24, etc., a stiffener 321a is provided on the power distribution unit support 32, so that the strength of the power distribution unit support 32 can be enhanced and the stability of the power distribution unit 31 can be improved. In addition, the stiffener 321a is provided at a location on the top 321 that avoids the area where the power distribution unit 31 is configured, so that, for example, the power distribution unit 31 can be firmly secured on the power distribution unit support 32. In this embodiment, there are multiple stiffeners 321a, each extending in a straight line in the front-back direction. It is understood that other forms of stiffener can also be provided, such as stiffeners extending in the left-right direction, or curved stiffeners.

<Control Means and Related Structures>

As shown in FIGS. 3, 12, and 15a, the control means 41 of the battery management system (BMS) and the low-voltage cable bundle 61 are configured in the gap S between the battery module 20L and the battery module 20R in the housing 10.

As shown in FIG. 5, a plurality of control means 41A, 41B and 41C (collectively referred to as control means 41 in the description herein when the plurality of control means are not distinguished) of the battery management system are configured between the battery module 20L and the battery module 20R in the housing 10. The control means 41A, 41B, and 41C are arranged in sequence from front to back. The control means 41A, 41B and 41C may be of electronic control units (ECUs). In this embodiment, the control means 41A and 41B are battery information collectors (BICs) and the control means 41C is a battery management unit (BMU). These control means 41A, 41B and 41C constitute a battery management system for intelligently managing and maintaining each battery module, preventing overcharging and overdischarging, extending service life, monitoring battery performance, etc.

It will be understood that the number and form of the control means described above are merely illustrative and do not constitute a limitation of the present invention.

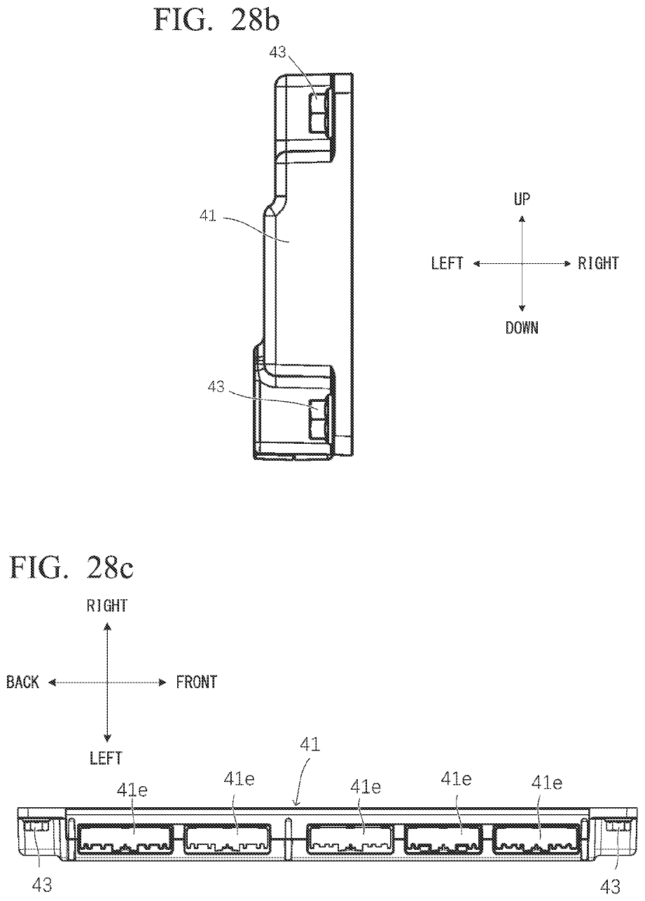

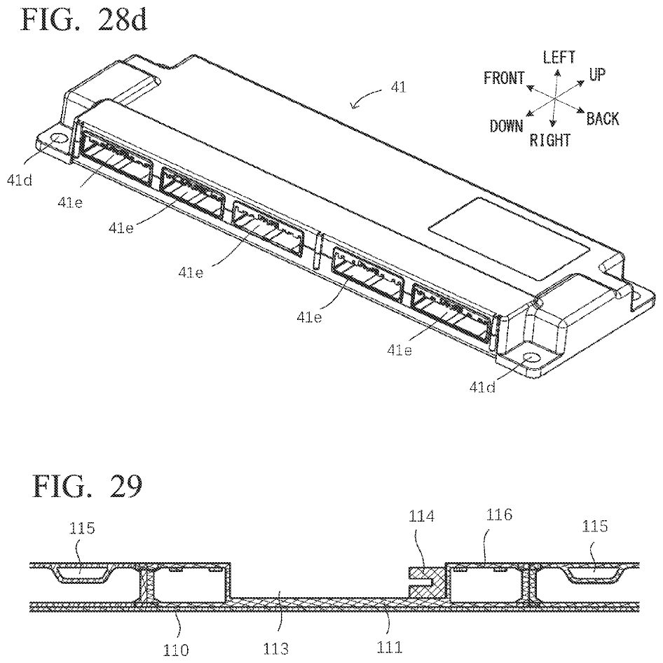

FIG. 28a is a schematic diagram of a three-dimensional structure of a control means in this embodiment; FIG. 28b is a schematic side view of the control means; FIG. 28c is a schematic elevation view of the control means; FIG. 28d is another schematic diagram of a three-dimensional structure of the control means. As shown in FIGS. 15a, 16, 17, 28a, 28b, 28c, and 28d, the control means 41 is substantially rectangular in shape, with the thickness direction approximately consistent with the left-right direction, the long side in the front-back direction, and the short side in the up-down direction.

Since the size in the thickness direction is the smallest, followed by the short side direction, and the largest in the long side direction, it is possible to reduce the size in the left-right direction of the gap S by making the thickness direction consistent with the left-right direction, thus miniaturizing the battery pack 100.

In addition, having the short side configured in the up-down direction enables the height of the control means 41 to be reduced compared to having the long side configured in the up-down direction, thereby suppressing the size of the battery pack 100 in the up-down direction and facilitating miniaturization.

Moreover, since the gap S is longer in size in the front-back direction (the direction in which the plurality of battery modules 20L or 20R are arranged), even if the long side of the control means 41 is configured in the front-back direction, it does not cause the battery pack 100 to increase in size in the front-back direction, which facilitates miniaturization.

As shown in FIGS. 15a and 17, the control means 41 is mounted on the high-voltage cable bundle support 112 by means of the control means support 42. In this way, the control means 41 is mounted using the high-voltage cable bundle support 112 of the high-voltage cable bundle 51, which enables a simple and compact structure and facilitates the miniaturization of the battery pack 100. As an example of the mounting manner, in this embodiment, the control means 41 is secured on the control means support 42 by bolts 43 as shown in FIG. 15a.

As shown in FIG. 15a, the control means support 42 includes a main part 42a and a base part 42b. The main part 42a is provided upright for mounting the control means 41, and the base part 42b is bent from the lower end of the main part 42a so as to extend in the left-right direction for mounting on the high-voltage cable bundle support 112. For example, the base part 42b is secured on the high-voltage cable bundle support 112 by bolts that are not shown. It will be appreciated that the base part 42b may also be secured on the high-voltage cable bundle support by other means, such as by welding.

In this way, the control means support 42 overall has approximately an L shape (in this embodiment, the L shape is seen from the rear), thereby having the technical effect of taking up less space and improving the space utilization inside the battery pack 100. In addition, the base part 42b, which extends from the lower end of the main part 42a in the left-right direction, makes it possible to firmly mount the control means support 42 on the high-voltage cable bundle support 112.

As shown in FIGS. 28c and 28d, the control means 41 has a connector 41e that is disposed in a lower portion of the control means 41 and (interface) faces downwards. In other words, the control means 41 is configured with the connector 41e facing downwards. The connector 65 on the low-voltage cable bundle 61 that will be described later is mated to the connector 41e from below to collect voltage, temperature information, etc. from the battery module 20. By positioning the connector 41e in the lower portion of the control means 41, it is possible to have a good waterproof effect. Specifically, due to the heating and cooling of the battery module 20, the interior of the housing 10 is prone to dew condensation, and dew droplets will form in and around the control means 41, and understandably, the dew droplets will flow downward. Therefore, by positioning the connector 41e in the lower portion of the control means 41 facing downwards, it is possible to prevent the water generated by the dew from flowing into the connector 41e and causing problems such as corrosion of the connector 41e.

Here, the connector 41e faces downwards in the sense that it is not limited to facing strictly downwards, but may be angled downwards, with the connector 41e facing downwards and at an angle greater than or equal to 0 but less than or equal to 90 degrees from the horizontal. As other embodiments, the angle may also be greater than or equal to 0 but less than or equal to 10 degrees, or greater than or equal to 0 but less than or equal to 30 degrees, 45 degrees, or 60 degrees. It is understood that the closer the angle is to the horizontal, the more effective the waterproofing. Also, the connector 41e may be at an angle of 0 degrees to the horizontal. Further, in the example of FIG. 28c, the control means 41 has a plurality of connectors 41e, and it is understood that the number of connectors 41e may vary depending on the function of the control means 41.

In addition, as shown in FIGS. 15a, 17 and 21a, a cable bundle securing part 42c is provided in the middle in the up-down direction of the main part 42a of the control means support 42 for securing the branch cable 612 of the low-voltage cable bundle 61 that will be described later. The cable bundle securing part 42c extends from the middle in the up-down direction of the main part 42a in the front-back direction, and is provided with a through-hole into which an inserted part of the ring support 44, which is attached to the cable bundle 612, is embedded, thereby securing the branch cable 612 on the cable bundle securing part 42c.

In this way, on the one hand, since the branch cable 612 of the low-voltage cable bundle 61 is secured in the middle in the up-down direction of the main part 42a, it is possible to ensure a stable position and maintain a stable connection with the battery module 20 so that the battery pack 100 has stable performance; on the other hand, since the control means support 42 is used to secure the low-voltage cable bundle 61, it is possible to simplify the structure and make the structure compact, which is advantageous for the arrangement of the control means 41 and the low-voltage connection assembly 60 in a limited space and is advantageous for the miniaturization of the battery pack 100.

In this embodiment, the branch cable 612 of the plurality of branch cables 612 that is electrically connected to the battery module 20R on the right side is secured by the cable bundle securing part 42c.

As shown in FIG. 15a, etc., the control means support 42 (base part 42b) is secured to the right of the high-voltage cable bundle support 112, such that the control means 41 is configured substantially off to the right from the middle in the gap S.

<Low-Voltage Connection Assembly and Related Structures>

Referring to FIGS. 3, 12 and 15a, the low-voltage connection assembly 60 is configured in the gap S between the battery module 20L and the battery module 20R in the housing 10, as described above.

The low voltage connection assembly 60 includes a low voltage cable bundle 61 with a low voltage cable bundle support 62, etc. The low voltage cable bundle 61 is mounted on the base plate 11 by mounting the low voltage cable bundle support 62 on the high voltage cable bundle support 112 and is located above the high voltage cable bundle support 112. Since the low-voltage cable bundle 61 is mounted on the high-voltage cable bundle support 112 via the low-voltage cable bundle support 62, i.e., the low-voltage cable bundle 61 is mounted using the high-voltage cable bundle support 112 of the high-voltage cable bundle 51, the structure can be simple and compact, which facilitates the miniaturization of the battery pack 100. Further, during assembly, the low-voltage cable bundle 61 and the high-voltage cable bundle 51, etc. can be mounted together and treated as a whole, thus enabling easy assembly.

As other embodiments, the low voltage cable bundle support 62 may also be mounted directly on the base plate 11.

As shown in FIG. 16, etc., the low-voltage connection assembly 60 is configured in the left-right direction to the left of the control means 41. That is, the control means 41 is configured in the gap S approximately off to the right from the middle, and the low-voltage connection assembly 60 is configured in the gap S approximately off to the left from the middle, with the control means 41 configured between the battery module 20R and the low-voltage connection assembly 60 (low-voltage cable bundle 61) on the right side, and the low-voltage connection assembly 60 configured between the control means 41 and the battery module 20L on the left side in the left-right direction. It is understood that, as other embodiments, the left and right positions of the low-voltage connection assembly 60 and the control means 41 may be interchangeable.

Further, as shown in FIGS. 12 and 16, etc., the low-voltage connection assembly 60 is configured in the up-down direction at a lower position than the control means 41. In other words, in this embodiment, the low-voltage connection assembly 60 is configured at the lower left side of the control means 41. Also, referring to FIGS. 12 and 16, etc., the low-voltage cable bundle 61 has a bent part near the reinforcement member 72 of the reinforcement assembly 70, which is bent to the right (or convex to the right) so that this part of the low-voltage cable bundle 61 is biased to the right with respect to the part adjacent thereto, in order to avoid interference with the reinforcement member 72. Thus, for example, it is possible to obtain the technical effect of avoiding interference between the reinforcement member 72 and the low-voltage cable bundle 61 and avoiding the abrasion of the low-voltage cable bundle 61 by the reinforcement member 72.

Further, in this embodiment, the high-voltage connection assembly 50 is configured in the receiving section 113 and the low-voltage connection assembly 60 is configured outside of the receiving section 113, thereby, for example, enabling the limited space in the base plate 11 to be used to improve the security of the battery pack 100 as efficiently as possible.

As shown in FIG. 18, etc., the low-voltage cable bundle 61 includes a main cable 611 and a plurality of branch cables 612. The main cable 611 is arranged to extend in a front-back direction. The plurality of branch cables 612 are electrically connected to the main cable 611. Specifically, the main cable 611 and the plurality of branch cables 612 are arranged between the control means 41 and the battery module 20, and the connector 65 is arranged under the control means 41. In this way, there is more space to arrange the connection between the branch cables 612 and the connector 65, so that the branch cables 612 are not easily broken and the life of the branch cables 612 is prolonged. In addition, only space for the connector is required under the control means 41, and the branch cables 612 do not occupy the space under the control means 41, so that the height of the control means 41 can be lowered and the shell of the battery pack has a reduced height when receiving the control means 41, thereby facilitating the miniaturization of the battery pack.

The connectors 65 are used to connect the control means 41; the connectors 66 are used to connect the battery module 20. The lead port 20c of the battery module 20 is provided at the upper part of the battery module 20, at a higher position, so that the branch cables 612 with the connector 66 extend upward to enable the connector 66 to be plugged into the lead port 20c of the battery module 20.

The connector 65 is supported on the low voltage cable bundle support 62 so that it can be kept in a stable position.

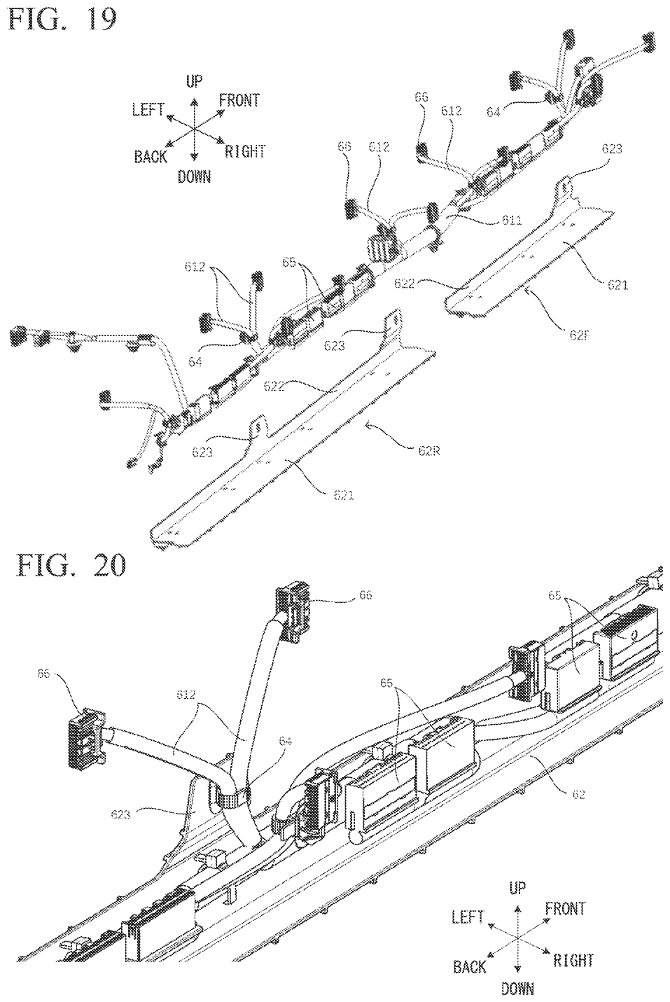

As shown in FIGS. 18 and 19, etc., there are two low-voltage cable bundle supports 62, namely, a low-voltage cable bundle support 62F and a low-voltage cable bundle support 62R, both of which are arranged in the front-back direction. In particular, the low-voltage cable bundle support 62F is configured in front of the reinforcement assembly 70 and the low-voltage cable bundle support 62R is configured at the rear of the reinforcement assembly 70, with the low-voltage cable bundle support 62F and the low-voltage cable bundle support 62R spaced apart to give way to the reinforcement assembly 70 and to prevent the reinforcement assembly 70 from causing a larger opening 72e (FIG. 12) to give way to the low-voltage cable bundle support 62, and thus causing degradation in strength. The rearward low-voltage cable bundle support 62R is relatively long and corresponds to the low-voltage cable bundle 61 of both control means 41; the forward low-voltage cable bundle support 62F is relatively short and corresponds to the low-voltage cable bundle 61 of one control means 41. Here, the “F” and “R” in reference symbols “62F” and “62R” are used to indicate “front” and “rear”, respectively, and the low-voltage cable bundle support 62 is collectively referred to when no distinction is made between front and rear.

The low-voltage cable bundle support 62 includes a main part 621 and a cable bundle securing part 623. The main part 621 is in the form of a plate and is arranged substantially horizontally to support the main cable 611 and the connector 65 of the low-voltage cable bundle 61. The cable bundle securing part 623 bends upward from the left and right ends (in this embodiment, the left end) of the main part 621 and extends upward to secure a portion of a plurality of branch cables 612 of the low-voltage cable bundle 61. Specifically, the branch cable 612 of the plurality of branch cables 612 that is electrically connected to the battery module 20L on the left side can be secured, with specific securing means, for example, by providing a through-hole in the cable bundle securing part 623 into which an inserted part of the ring support 64 which is attached to the branch cable 612 is embedded, thereby securing the branch cable 612 on the cable bundle securing part 623.

In this way, the branch cable 612 of the low-voltage cable bundle 61 is secured at the upwardly extending location of the cable bundle securing part 623, and thus it is able to keep its position stable and keep its connection to the battery module 20 stable, so that the battery pack 100 has stable performance

Referring to FIG. 16, a bulging part 112b is provided on the high-voltage cable bundle support 112, which is located in an up-down direction opposite the gap between the front low-voltage cable bundle support 62 and the rear low-voltage cable bundle support 62. The part of the main cable 611 of the low voltage cable bundle 61 between the front low voltage cable bundle support 62 and the rear low voltage cable bundle support 62 is supported by, and is also secured on, the bulging part 112b. Specifically, the bulging part 112b is provided with a through-hole, and an inserted part of the ring support 63 over the central part of the main cable 611 (specifically, the curved part described above) is embedded in the through-hole, thereby securing the main cable 611 on the high-voltage cable bundle support 112.

In this way, the main cable 611 is supported by the bulging part 112b of the high voltage cable bundle support 112 at the position where it cannot be supported by the low voltage cable bundle support 62, thus effectively keeping the low voltage cable bundle 61 (main cable 611) in a stable position and improving the safety and performance stability of the battery pack 100.

The ring supports 44, 63 and 64 may be made of a metal, or may be made of a plastic.

In addition, as other embodiments, the low-voltage cable bundle 61 may also be secured on the high-voltage cable bundle support 112.

<Reinforcement Members and Related Structures>

As shown in FIGS. 6 to 8, a reinforcement assembly 70 is provided in the housing 10, which is configured in the middle in the front-back direction in the housing 10 and extends in the left-right direction, mainly for strengthening the housing 10 in the left-right direction. For example, when the vehicle 200 is subjected to a lateral impact, the reinforcement assembly 70 can resist the lateral impact force, prevent deformation of the housing 10, and prevent the battery module 20 inside the housing 10 from being damaged by the impact. In this embodiment, one reinforcement assembly 70 is provided, however, as other embodiments, a plurality of reinforcement assemblies may be provided, which are spaced apart and arranged in a front-back direction. In this embodiment, the reinforcement assembly 70 may also be referred to as a beam.

In this embodiment, the reinforcement assembly 70 is carried on the upper surface of the base plate 11, i.e., over the base plate 11. Thus, it is possible to avoid interference of the reinforcement assembly 70 with the receiving section 113 or the coolant channel 115 in the base plate 11. Compared with a structure in which the reinforcement member is provided below the plate 116 or at approximately the same height, it is not necessary to provide a shunning part on the reinforcement assembly 70 or on the holding part 113 and the coolant channel 115 to avoid interference, thus making it possible to simplify the structure and reduce manufacturing costs. Also, as described above, in this embodiment, the receiving section 113 is formed in the form of a long slot extending in the front-back direction, and the reinforcement assembly 70 extends in the left-right direction, thereby extending intersectionally with the receiving section 113. Also, the reinforcement assembly 70 may be described as extending in the extension direction of the plate 116 or extending along the upper surface of the plate 116.

FIG. 10 is a schematic diagram of the three-dimensional structure of the reinforcement member related to an embodiment. As shown in FIGS. 6 to 8 and FIGS. 10 to 12, the reinforcement assembly 70 includes a first connection member 71, a second connection member 73, and a reinforcement member 72. The first connection member 71 is supported on the base plate 11 of the housing 10 and extends from the left side plate 12 toward the middle in the left-right direction. The second connection member 73 is supported on the base plate 11 and extends from the right side plate 12 towards the middle in the right-left direction. A spacer is provided between the first connection member 71 and the second connection member 73. The reinforcement member 72 extends in the left-right direction, and is connected between the first connection member 71 and the second connection member 73, as well as having an upwardly protruding arch structure to avoid the low-voltage cable bundle 61, etc., configured in the gap S. One ends of the first connection member 71 and the second connection member 73 are connected to the reinforcement member 72, and the other ends may be connected to the side plate 12 of the housing 10.

By providing an arch-shaped reinforcement member 72, for example, it is possible to ensure the strength of the reinforcement assembly 70 while avoiding the low-voltage cable bundle 61, etc., compared to providing a breach in the reinforcement member to avoid the low-voltage cable bundle.

As shown in FIG. 12, the reinforcement 72 overall has a generally inverted U shape and includes an arch-shaped part 72a, upright parts 72b, and a secure part 72c. The arch-shaped part 72a is equivalent to the middle part of the U shape, and its upper and lower surfaces are bent upward and arched upward so as to have an arch shape. There are two upright parts 72b, which extend downward from the left and right ends of the arch-shaped part 72a, respectively, opposite to the first connection part 71 and the second connection part 73 in the left-right direction. That is, when viewed in the left-right direction, the upright part 72b overlaps with the first connection part 71 and the second connection part 73. In this way, when the vehicle is subjected to a lateral impact, for example, the upright portion 72b abuts the first connection member 71 and the second connection member 73 from the left-right direction, reliably conveys the force from one of the first connection member 71 or the second connection member 73 to the arch-shaped part 72a above, and from the arch-shaped part 72a to the other of the first connection member 71 or the second connection member 73, thereby enabling effective enhancement of the strength of the reinforcement assembly 70 as a whole, i.e., the ability of the reinforcement assembly 70 to resist external forces.

An opening 72e is formed by the inner surface of the arch-shaped part 72a and the two upright parts 72b, and accommodates the low-voltage cable bundle 61 and the bulging part 112b of the high-voltage cable bundle support 112.

There are two secure parts 72c, which protrude from the connection position of the arch-shaped part 72a and the upright part 72b to the outer part in the left-right direction, and are secured on the first connection member 71 and the second connection member 73 by bolts 16d. In this way, when the vehicle is subjected to a lateral impact, for example, the force can be effectively conveyed by the first connection member 71 or the second connection member 73 to the arch-shaped part 72a, and the overall strength of the reinforcement assembly 70 can be effectively enhanced, i.e., the ability of the reinforcement assembly 70 to resist external forces can be enhanced.

The bolt 16d is provided upright and passes through the secure part 72c, the first connection part 71 and the second connection part 73, and the plate 116, and the lower end that has passed through is screwed with the nut 16e, so that not only is the secure part 72c secured on the first connection part 71 and the second connection part 73, but also the first connection part 71 and the second connection part 73 are secured on the base plate 11. In this way, the reinforcement member 72 is secured on the first connection part 71 and the second connection part 73 by the structure of securing the first connection part 71 and the second connection part 73 on the base plate 11, thereby simplifying the structure and reducing the cost, as well as making the structure compact and facilitating the miniaturization of the battery pack 100.

In addition, a plurality of recesses 72d are provided on the arch-shaped part 72a and the upright part 72b, and specifically, the recesses 72d are triangular recesses. Thus, the weight of the reinforcement member 72 is reduced while the strength of the reinforcement member 72 is guaranteed.

In this embodiment, as shown in FIG. 12, the lower end 72b1 of the upright part 72b extends downward into the receiving section 113 so that, for example, when the vehicle is laterally impacted, the receiving section 113 shrinks and deforms in the left-right direction, and then the left and right side walls of the receiving section 113 (i.e., the left and right side walls of the recess) contact the lower end 72b1 of the upright part 72b, so that the reinforcement member 72 can withstand the external force in the left-right direction and enhance the strength of the base plate 11 in the left-right direction.

Further, in this embodiment, the side portions of this lower end portion 71b1 are in contact with the left and right edges of the receiving section 113 (the edges of the opening 116a of the plate 116, referring to FIG. 15b), thereby enabling reliable enhancement of the strength of the base plate 11 in the left-right direction. Here, the edges of the openings 116a are part of the side walls of the receiving section 113, and it is understood that the lower end portion 71b1 of the upright portion 71b can be further extended downward while increasing the contact area or contactable area with the side walls of the receiving section 113 to further enhance the strength of the base plate 11.

In addition, as described above, the reinforcement member 72 is pressed against the high-voltage cable bundle support 112, specifically the lower end 72b1 of the upright part 72b of the reinforcement member 72 is pressed against the middle of the length of the main part 112a of the high-voltage cable bundle support 112, thereby preventing movement or deformation of the high-voltage cable bundle support 112 in the up-down direction.

Furthermore, as described above, the reinforcement member 72 is pressed against the main part 112a of the high-voltage harness holder 112 by the cushioning member 74 (FIG. 21c), and specifically the lower end 72b1 of the upright part 72b is pressed against the main part 112a of the high-voltage cable bundle support 112 by the cushioning member 74, so that damage to the high-voltage cable bundle support 112 can be prevented.

In this embodiment, the reinforcement member 72 is molded separately from the first connection member 71 and the second connection member 73, however, the invention is not limited to this, for example, the reinforcement member 72 may also be molded integrally with the first connection member 71 and/or the second connection member 73.

FIG. 30 is a schematic diagram of the structure of a battery pack related to another embodiment of the present invention. The difference between the embodiment shown in FIG. 30 and the above embodiment is that, in the above embodiment, an opening 116a is provided in the plate 116, whereas in FIG. 30, instead of the structure of the plate 116, a plate 118 is provided (an example of the first plate), which is approximately equal in size to the plate 111 in the left-right direction, which does not have an opening at the position opposite the receiving section 113, and which forms the ceiling of the receiving section 113. In addition, the receiving section 113 runs through the front and/or rear portions of the base plate 11, i.e., in this embodiment, the receiving section 113 is formed in the form of a long hole extending in the front-back direction. During assembly, the high-voltage cable bundle 51 can be inserted into the receiving section 113 from the front or the rear through the opening of the receiving section 113 (the long hole). Also, in this embodiment, the high-voltage cable bundle support 112 in the above embodiment is omitted. Furthermore, in this embodiment, in the state where the high voltage cable bundle 51 is inserted into the receiving section 113, the high-voltage cable bundle 51 has a portion that is horizontally exposed outside the receiving section 113, and this portion can be secured on the base plate 11 to secure the high-voltage cable bundle 51 on the base plate 11.

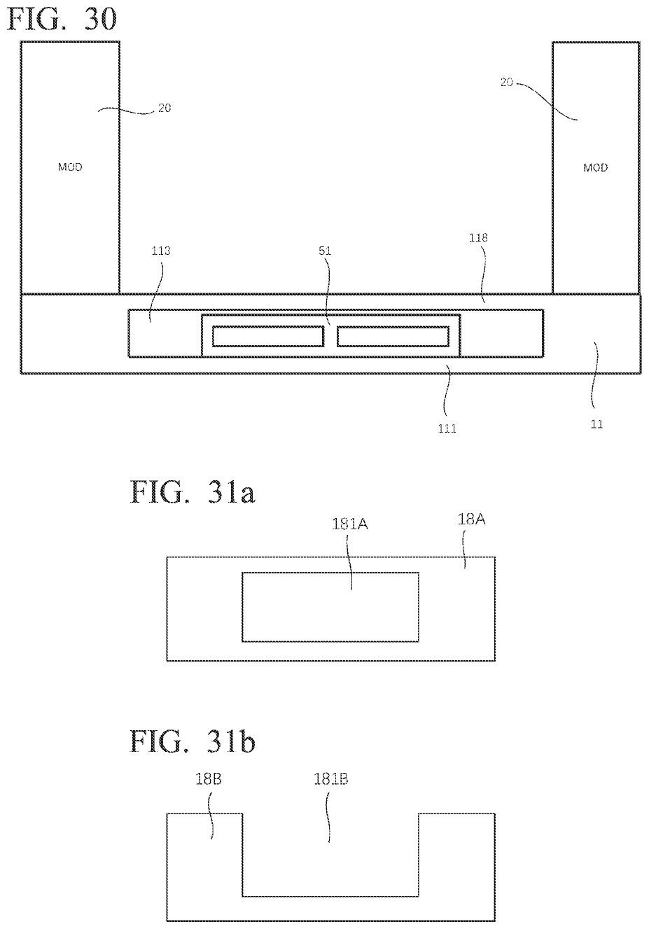

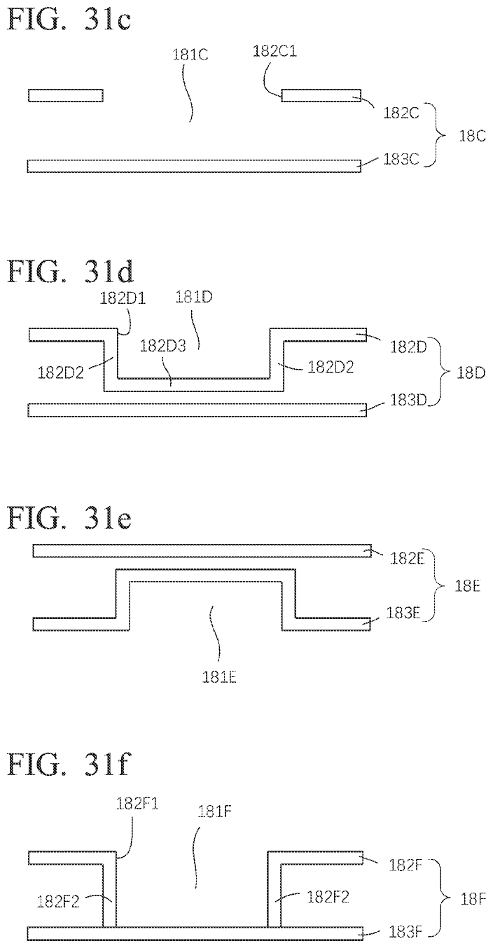

FIGS. 31a to 31f illustrate some examples of a base plate and a receiving section in the base plate by way of a partial cross-sectional schematic. In FIG. 31a, the housing 10 of the battery pack 100 has a base plate 18A with a receiving section 181A comprising a cavity in the base plate 18A. In addition, in this structure, the thickness of the base plate 18A is thicker (larger than the size in the up-down direction of the receiving section 181B), or, alternatively, a thickening section can be provided on the base plate 18A with the thickness of the thickening section being greater than the thickness of the part adjacent thereto, and the receiving section 181A can be provided in the thickening section 181A.

In FIG. 31b, the housing 10 has a base plate 18B, and a recess (not shown) can be provided on the upper surface of the base plate 18B, and can form the receiving section 181B. In this structure, the thickness of the base plate 18B is thicker (larger than the size in the up-down direction of the receiving section 181B), or, alternatively, a thickening part can be provided on the base plate 18B with a thickness greater than the thickness of the part adjacent thereto, and a receiving section 181B can be provided in the thickening part. Similarly, a recess (not shown) can be provided on the lower surface of the base plate 18B, and can also form the receiving section.

In FIG. 31c, the housing 10 has a base plate 18C, the base plate 18C has a plate 182C and a plate 183C, the plate 182C and the plate 183C are configured vertically opposite each other and spaced apart, a through opening 182C1 is provided in the upper plate 182C, a receiving section 181C is formed between the plate 182C and the plate 183C, and the high voltage connection assembly 50 can be configured in the receiving section 181C through the through opening 182C1. With such a structure, the size of the receiving section 181C in the left-right direction can be larger and can accommodate a high-voltage connection assembly with a larger size in the left-right direction. In addition, the size of the opening 182C1 in the left-right direction may be smaller than the size of the high voltage connection assembly 50 in the left-right direction. Similarly, a through opening (not shown) is provided in the lower plate 183C and a receiving section may also be formed between the plate 182C and the plate 183C.

In FIG. 31d, the housing 10 has a base plate 18D, the base plate 18D has a plate 182D and a plate 183D, and the plate 182D and the plate 183D are configured opposite each other vertically and spaced apart. The upper surface of the upper plate 182D is provided with a recess which is projected from the lower surface side of the plate 182D, and a receiving section 181D is formed by the recess. With such a structure, the recess (projection) can be considered as a stiffener (similar to a pressed rib) on the plate 182D, and thus the strength of the plate 182D as well as the base plate 18D can be enhanced.

Alternatively, as shown in FIG. 31d, the receiving section 181D (recess) has an opening 182D1, a partition wall 182D2, and a bottom wall 182D3, the opening 182D1 is set on the plate 182D, the partition wall 182D2 extends from the left and right edges of the opening 182D1 toward the plate 183D, i.e., downward, and the bottom wall 182D3 is connected between the partition walls 182D2 on the left and right sides.

In FIG. 32e, the housing 10 has a base plate 18E, the base plate 18E has a plate 182E and a plate 183E, and the plate 182E and the plate 183E are configured opposite each other vertically and spaced apart. The lower surface of the lower plate 183E is provided with a recess which is a protrusion seen from the upper surface side of plate 183E, and the recess forms a receiving section 181E. In addition, the protrusion may be spaced apart from plate 182E or may contact the plate 182E.

In FIG. 31f, the housing 10 has a base plate 18F, the base plate 18F has a plate 182F and a plate 183F, and the plate 182F and the plate 183F are configured opposite each other vertically and are spaced apart. The upper plate 182F is provided with a through opening 182F1, and the left and right edges of the through opening 182F1 are provided with a partition wall 182F2 extending downward, so that the opening 182F1 and the partition wall 182F2 form the receiving section 181F, i.e., the receiving section 181F has an opening 182F1 and a partition wall 182F2, the opening 182F1 is formed on the plate 182F, and the partition wall 182F2 defines the left and right boundaries of the receiving section 181F. In this structure, the lower end of the partition wall 182F2 can be set to come in contact with the plate 183F to form a reliable support between the plate 182F and the plate 183F and to enhance the strength of the base plate 18F in the up-down direction. Similarly, a through opening (not shown) is provided in the lower plate 183F, and a partition wall extends upward on the left and right edges of the opening, so that the opening and partition wall form a receiving section as well.

Alternatively, the lower end of the partition wall 182F2 may not touch the plate 183F, and the partition wall 182F is pressed against the plate 183F when the base plate 18F is subjected to a force in the up-down direction, so that such a partition wall 182F can also enhance the strength of the base plate 18F.

In addition, the structure of FIG. 31f can be seen to be obtained by omitting the bottom wall of the receiving section 181E in FIG. 31e.

The structure shown in FIGS. 31d to 31f can be compared with that shown in FIGS. 31a and 31b to obtain the technical effect of reducing the weight of the base plate while taking into account the strength of the base plate.

One assembly method for the battery pack of the embodiment shown in FIGS. 2 to 29 will be described below.

The assembly method comprises the following:
S1, securing the battery module 20 on the base plate 11;
S2, securing the high-voltage cable bundle 51, the low-voltage cable bundle 61, and the control means 41 on the high-voltage cable bundle support 112, thereby forming a single whole (referred to as the first assembly)
S3, securing the first assembly on the base plate 11, and
S4, securing the top cover 13 with respect to the base plate 11 to form the battery pack 100.

Using this method, the high-voltage cable bundle 51, the low-voltage cable bundle 61 and the control means 41 are secured on the high-voltage cable bundle support 112 and treated together as a first assembly, thereby making the battery pack 100 easy and convenient to assemble.

The order of S1 and S2 above is not limited, and S1 can be executed first and S2 executed later. It is also possible to execute them in reverse.

Optionally, the S2 includes: securing the control means 41 on the high voltage cable bundle support 112 via the control means support 42; and securing the low voltage cable bundle 61 on the high voltage cable bundle support 112 via the low voltage cable bundle support 62.

The control means 41 may be mounted first on the control means support 42 and then on the high voltage cable bundle support 112, and the control means 41 support may also be mounted first on the high voltage cable bundle support 112 and then on the control means 41. The same applies to the low voltage cable bundle 61 and the low voltage cable bundle support 62.

Embodiments of the present invention provide a battery pack 100 and a vehicle 200 having the battery pack 100, the battery pack 100 comprising: a housing 10 comprising a base plate 11 provided with a receiving section 113; a battery module 20 arranged over the base plate 11; and a high voltage connection assembly 50 electrically connected to the battery module 20 and accommodated in the receiving section 113.

In addition, the connector 52 and the connector 53 are provided at the front and rear ends of housing 10, respectively. The power distribution unit 31 is electrically connected to the connector 52 and the plurality of battery modules 30 and electrically connected to the connector 53 and the plurality of battery modules 30, with the power distribution unit 31 provided over the individual battery modules 20 and provided closer to the connector 53 at the rear than the connector 52 at the front.

Further, the battery module 20 includes a left side battery module 20L and a right side battery module 20R with a gap S between the left side battery module 20L and the right side battery module 20R. The control means 41 is provided in the gap S. The low-voltage connection assembly 60, which electrically connects the battery modules 20L and 20R and the control means 41, is also provided in the gap S. The low-voltage connection assembly 60 is located between the control means 41 and the battery module 20R and is located below (i.e., diagonally below) the control means 41.

In addition, a reinforcement assembly 70 is provided over the base plate 11, and the reinforcement assembly 70 extends in the left-right direction as a whole. The reinforcement assembly 70 includes a reinforcement member 72, a first connection member 71, and a second connection member 73. The reinforcement member 72 includes an arch-shaped part 72a arranged in the gap S and arched upward, and a low-pressure connection assembly 60 passes through the inner side of the arch-shaped part 72a. One end of the first connection member 71 and one end of the second connection member 73 are connected to the reinforcement member 72, and the other end can be connected to the side plate 12 of the housing 10.

With the structure of this embodiment, for example, when the vehicle is subjected to a lateral impact, the battery pack 100 is deformed and the battery module 20 moves in the extension direction of the base plate 11, however, since the high-voltage connection assembly 50 is configured in the base plate 11 under the battery module 20, the battery module 20 does not easily impact the high-voltage connection assembly 50, thereby suppressing deformation or breakage of the high-voltage connection assembly 50, etc., and improving the safety and reliability of the battery pack 100.

In addition, positioning the power distribution unit 31 above the single-side battery module 20 not only improves the convenience of installation of the power distribution unit 31, but also improves the stability of the power distribution unit 31, and reduces the overall space occupied by the power distribution unit 31 and increases the energy density of the battery pack 100 (without occupying the middle gap, which minimizes the width of the battery pack).

Additionally, the power distribution unit 31 is provided close to the connector 53, which enables the cable length of the high voltage connection assembly 50 to be reduced, reducing costs. In addition, the power distribution unit 31 is provided close to the connector 53 at the rear of the battery pack so that the front portion of the battery pack housing 10 does not need to be provided with a projecting portion to accommodate the power distribution unit 31, which in turn allows more space in the cabin corresponding to the location of the battery pack to accommodate the passenger's feet.

Also, providing the control means 41 upright in the gap S makes reasonable use of the space of the housing 10, reduces the overall space occupied by the control means 41 in the battery pack 100, improves the energy density of the battery pack 100, and also facilitates assembly.

In addition, the reinforcement assembly 70 strengthens the housing 10 of the battery pack 100, and the arch-shaped part 72a suppresses the reduction of the strength of the reinforcement assembly 70, distributes the force effectively, and better deforms and cushions the battery pack 100 when it is subjected to an impact.

The terms “first, second, third, etc.” or similar terms such as Module A, Module B, Module C, etc. are used herein only to distinguish similar objects and do not imply a particular ordering of objects, and it is understood that particular orders or sequences may be interchanged where permitted so that embodiments of the present application described herein can be implemented in an order other than that illustrated or described herein.

The term “including” as used herein should not be construed as limiting to what is listed thereafter, and it does not exclude other components or steps. Accordingly, it should be interpreted as designating the presence of the described feature, entity, step or component mentioned, but does not exclude the presence or addition of one or more other features, entities, steps or components and groups thereof. Thus, the expression “unit comprising parts A and B” should not be limited to a unit comprising only parts A and B.

References in this specification to “an embodiment” or “embodiments” mean that the particular feature, structure or characteristics described in conjunction with that embodiment are included in at least one embodiment of the present invention. Thus, the terms “in an embodiment” or “in embodiments” appearing throughout this specification do not necessarily refer to the same embodiment, but may refer to the same embodiment. In addition, in one or more embodiments, the particular features, structures, or characteristics can be combined in any suitable manner, as would be apparent from the present disclosure to one skilled in the art.

In addition, the above is only a preferred embodiment of the present application and the technical principles used. One skilled in the art will understand that the present invention is not limited to the particular embodiments described herein, and that various obvious variations, readjustments and substitutions can be made by those skilled in the art without departing from the scope of protection of the present invention. Therefore, although the present application has been described in some detail through the above embodiments, the present invention is not limited to the above embodiments, but may include more other equivalent embodiments without departing from the conception of the present invention, all of which fall within the scope of protection of the present invention.

What is claimed is:

1. A battery pack comprising:
a housing comprising a base plate;
a battery module configured on the base plate and comprising a first battery module and a second battery module, a gap provided between the first battery module and the second battery module;
a low-voltage connection assembly provided in the gap and electrically connected to the battery module;
a reinforcement member provided on the base plate and comprising an arch-shaped part provided in the gap and arched upward, the low-voltage connection assembly passing through the inner side of the arch-shaped part.

2. The battery pack according to claim 1, further comprising a first connection member and a second connection member provided on the base plate, the first connection member and the second connection member extending in the extension direction of the base plate, the two ends of the reinforcement member secured to each of the first connection member and the second connection member.

3. The battery pack according to claim 1, further comprising a control means provided in the gap and electrically connected to the battery module via the low-voltage connection assembly.

4. The battery pack according to claim 2, wherein the reinforcement member comprises the arch-shaped part and an upright part, the upright part extends downwards from the two ends of the arch-shaped part, and overlaps the first connection member and/or the second connection member as seen from the extension direction of the first connection member and the second connection member.

5. The battery pack according to claim 3, wherein the arch-shaped part is provided with a plurality of recesses.

6. The battery pack according to claim 2, wherein the reinforcement member comprises a secure part, and a bolt passes through the secure part and the first connection member or the second connection member in sequence and is secured on the base plate.

7. The battery pack according to claim 1, further comprising a first high-voltage connection assembly, the base plate provided with a receiving section, the first high-voltage connection assembly accommodated in the receiving section.

8. The battery pack according to claim 7, wherein the base plate is provided with a coolant channel.

9. The battery pack according to claim 8, wherein the reinforcement member is provided over the base plate.

10. The battery pack according to claim 8, wherein a part of the coolant channel distant from the centerline of the base plate is upstream along the liquid flow and a part of the coolant channel closer to the centerline of the base plate is downstream along the liquid flow, in which the centerline extends in the extension direction of the base plate.

11. The battery pack according to claim 7, wherein
the housing is provided with a first connector and a second connector at the front and rear ends, respectively;
the battery pack further comprises a power distribution unit provided over the individual battery module and electrically connected to the battery module, electrically connected to the first connector via the first high-voltage connection assembly, and electrically connected to the second connector via the second high-voltage connection assembly.

12. The battery pack according to claim 7, wherein
the first high-voltage connection assembly comprises a high-voltage cable bundle and a high-voltage cable bundle support, and
the high-voltage cable bundle is disposed in the receiving section, and the high-voltage cable bundle support covers the high-voltage cable bundle from above and forms a ceiling of the receiving section.

13. The battery pack according to claim 12, wherein a cushioning member is provided between the high-voltage cable bundle support and the reinforcement member.

14. The battery pack according to claim 12, wherein the low-voltage connection assembly comprises a low-voltage cable bundle and a low-voltage cable bundle support, and the low-voltage cable bundle is secured on the high-voltage cable bundle support via the low-voltage cable bundle support.

15. The battery pack according to claim 1, wherein
the battery module comprises a first battery module and a second battery module, a gap is provided between the first battery module and the second battery module, and the low-voltage connection assembly is provided in the gap, and
the battery pack further comprises a control means provided in the gap, located between the control means and the second battery module, and located below the control means.

16. The battery pack according to claim 15, wherein
the control means is secured on the base plate via the control means support,
the control means support comprises a main part and a base part,
the main part is configured vertically with respect to the base plate and holds the control means, and
the base part is bent from the lower end of the main part and mounted on the base plate.

17. A vehicle comprising the battery pack according to claim 1.
